(19) United States
(12) Patent Application Publication
(10) Pub. No.: US 2015/0046549 A1
(43) Pub. Date: Feb. 12, 2015

(54) TOOL SELECTION METHOD AND STORAGE MEDIUM

(71) Applicant: FUJITSU LIMITED, Kawasaki-shi (JP)

(72) Inventors: Kuniharu TAKAYAMA, Tama (JP); Naoto TAKAHASHI, Kawasaki (JP); Satoshi MUNAKATA, Kawasaki (JP)

(73) Assignee: FUJITSU LIMITED, Kawasaki-shi (JP)

(21) Appl. No.: 14/451,556

(22) Filed: Aug. 5, 2014

(30) Foreign Application Priority Data
Aug. 8, 2013 (JP) 2013-165352

(51) Int. Cl. G06Q 10/10; H04L 12/58

(52) U.S. Cl. CPC G06Q 10/107; H04L 51/16
USPC 709/206

(57) ABSTRACT

In a tool selection method, a computer refers to information of work models each associating an attribute of a work tool with a pair of an object character string related to a work object and an activity character string including verbs related to work activities, the information being stored in a memory, detects a pair of an object character string and an activity character string from an e-mail, specifies a work model corresponding to the detected pair, and specifies a work tool having an attribute corresponding to the specified work model.

### CROSS-REFERENCE TO RELATED APPLICATION

This application is based upon and claims the benefit of priority of the prior Japanese Patent Application No. 2013-165352, filed on Aug. 8, 2013, the entire contents of which are incorporated herein by reference.

### FIELD

The embodiments discussed herein relate to a tool selection method and a storage medium.

### BACKGROUND

Today, e-mail has become an indispensable tool for many people. E-mail may be used personally, or may be used among organizations such as corporations, schools, or the like. E-mail is a communication tool for communicating information originated from one person to one or more persons. Although it is effective for communicating information between individuals, for example, using e-mail for a meeting or the like where a group of people exchanges their opinions may result in a situation in which it is difficult to recognize the sender-receiver relation or the chronological order of statements, making it difficult to grasp the progress of the discussion.

Accordingly, it is more efficient to use a video conference system than e-mail for a meeting or the like. However, people who are familiar with e-mail may use the familiar e-mail, although recognizing its low work efficiency, rather than using an unfamiliar video conference system. Various works, not limited to a meeting using e-mail, are also sometimes performed using a familiar tool, although there are tools that may raise the work efficiency. In view of such a situation, there have been devised various ways to make a work-suitable tool more user-friendly.

For example, there is proposed a business coordination processing system which, when a user transmits an e-mail having the content and process sequence of the business described in its header, receives the e-mail and activates a business process based on the information described in the header of the received e-mail. In addition, there is proposed a workflow system which selects a suitable communication tool according to the work selected by a user and the number of workers performing the work.

Please see, for example, Japanese Patent Laid-Open Patent Publication No. 09-261267 and Japanese Patent Laid-Open No. 2008-146520

The aforementioned business coordination processing system uses e-mail as a tool that informs the system of the business content. Therefore, even a user who is unfamiliar with the operation of the business coordination processing system is able to operate the business coordination processing system using the familiar e-mails. However, the technique merely uses e-mail as an operation interface of the business coordination processing system and therefore it is unlikely to be used by a user who does not intend to proactively use the business coordination processing system.

In the case of the aforementioned workflow system, the workflow system automatically selects a suitable communication tool according to a work and the number of workers. Therefore, a user may recognize a communication tool which is more suitable for the work than e-mail. As a result, a user who is unfamiliar with the communication tool selected by the workflow system may be motivated to use the communication tool.

The more frequent a communication tool selected by the workflow system is suitable for a work, the more motivated the user will become, as described above, which may contribute to the work efficiency. However, the more frequent a communication tool which is not suitable for a work is selected, the less motivated the user will become, and there may even arise an intention to avoid using the communication tool proposed by the workflow system.

Therefore, the inventors have considered about a mechanism for raising the possibility of selecting a communication tool which is suitable for a work, in order to motivate a user to use a communication tool and improve work efficiency.

### SUMMARY

According to an aspect of the disclosure, there is provided a non-transitory computer-readable storage medium storing a computer program that causes a computer to execute a process including: referring to information of work models each associating an attribute of a work tool with a pair of an object character string related to a work object and an activity character string including verbs related to work activities, the information being stored in a memory, to detect a pair of an object character string and an activity character string from an e-mail; specifying a work model corresponding to the detected pair; and specifying the work tool having the attribute corresponding to the specified work model.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an exemplary tool selection method according to a first embodiment;

FIG. 2 illustrates an example of information processing system according to a second embodiment;

FIG. 3 is a first drawing illustrating exemplary communication tools applicable to an information processing system according to the second embodiment, together with their characteristics;

FIG. 4 is a second drawing illustrating exemplary communication tools applicable to the information processing system according to the second embodiment, together with their characteristics;

FIG. 5 illustrates an example of hardware capable of realizing a function of a terminal device according to the second embodiment;

FIG. 6 is a block diagram illustrating an exemplary function included in a server device according to the second embodiment;

FIG. 7 illustrates an exemplary (notification type) work model being used by the server device according to the second embodiment;

FIG. 8 illustrates an exemplary (discussion type) work model being used by the server device according to the second embodiment;

FIG. 9 illustrates an exemplary (cooperative type) work model being used by the server device according to the second embodiment;

FIG. 10 illustrates an example of information indicating the use frequency of the work model being used by the server device according to the second embodiment;

FIG. 11 illustrates an exemplary model-property relation table used by the server device according to the second embodiment;

FIG. 12 illustrates an exemplary execution condition-property relation table used by the server device according to the second embodiment;

FIG. 13 illustrates an example of information indicating the use frequency of the communication tool being used by the server device according to the second embodiment;

FIG. 14 illustrates an exemplary text description of an e-mail to be processed by the server device according to the second embodiment;

FIG. 15 illustrates an exemplary work instance segment extracted from an e-mail by the server device according to the second embodiment;

FIG. 16 is an explanatory drawing of a procedure of determining the extraction condition of the work model, among the procedures to be performed by the server device according to the second embodiment;

FIG. 17 illustrates an exemplary start screen of a notification type communication tool according to the second embodiment;

FIG. 18 is an explanatory drawing of a procedure of embedding the work instance segment in notification type communication tool, among the procedures to be performed by the server device according to the second embodiment;

FIG. 19 is a flowchart describing the flow of a recommendation procedure of the communication tool according to the second embodiment;

FIG. 20 illustrates an exemplary text description of an e-mail to be processed by the server device according to an application example (application example A) of the second embodiment;

FIG. 21 illustrates an exemplary work instance segment extracted from an e-mail by the server device according to the application example (application example A) of the second embodiment;

FIG. 22 is an explanatory drawing of a procedure of determining the extraction condition of the work model, among the procedures to be performed by the server device according to the application example (application example A) of the second embodiment;

FIG. 23 illustrates an exemplary text description of an e-mail to be processed by the server device according to an application example (application example B) of the second embodiment;

FIG. 24 illustrates an exemplary work instance segment extracted from an e-mail by the server device according to the application example (application example B) of the second embodiment;

FIG. 25 is an explanatory drawing of a procedure of determining the extraction condition of the work model, among the procedures to be performed by the server device according to the application example (application example B) of the second embodiment;

FIG. 26 is an explanatory drawing of a procedure of embedding the work instance segment in a discussion type communication tool, among the procedures to be performed by the server device according to the application example (application example B) of the second embodiment;

FIG. 27 is an explanatory drawing of an exemplary operation of a discussion type communication tool according to the application example (application example B) of the second embodiment.

FIG. 28 illustrates an exemplary text description of an e-mail to be processed by the server device according to an application example (application example C) of the second embodiment;

FIG. 29 illustrates an exemplary work instance segment extracted from an e-mail by the server device according to the application example (application example C) of the second embodiment;

FIG. 30 is an explanatory drawing of a procedure of determining the extraction condition of the work model, among the procedures to be performed by the server device according to the application example (application example C) of the second embodiment;

FIG. 31 is an explanatory drawing of a procedure of embedding the work instance segment in a cooperative type communication tool, among the procedures to be performed by the server device according to the application example (application example C) of the second embodiment; and

FIG. 32 is an explanatory drawing of an exemplary operation of a cooperative type communication tool according to the application example (application example C) of the second embodiment.

### DESCRIPTION OF EMBODIMENTS

Several embodiments will be described below with reference to the accompanying drawings, wherein like reference numerals refer to like elements throughout.

### 1. First Embodiment

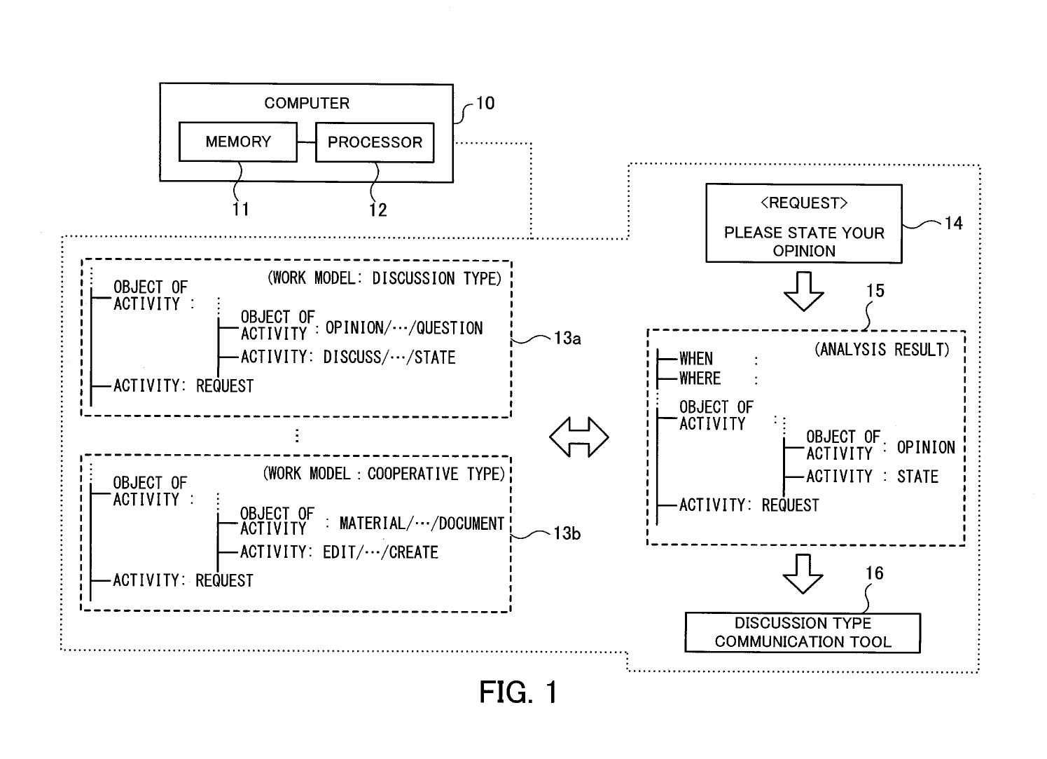

A first embodiment will be described, referring to FIG. 1. FIG. 1 illustrates an exemplary tool selection method according to the first embodiment. The tool selection method according to the first embodiment is realized using hardware resources of a computer 10.

As illustrated in FIG. 1, the computer 10 has a memory 11 and a processor 12.

The memory 11 is a volatile storage device such as a RAM (Random Access Memory), or a non-volatile storage device such as an HDD (Hard Disk Drive) and a flash memory. The processor 12 is a CPU (Central Processing Unit), a DSP (Digital Signal Processor), or the like. In addition, the processor 12 may be an electronic circuit such as an ASIC (Application Specific Integrated Circuit) or an FPGA (Field Programmable Gate Array). The processor 12 executes a program stored in, for example, the memory 11 or another memory.

The memory 11 stores information of work models 13a and 13b each associating an attribute of a work tool 16 with a pair of an object character string related to work objects and an activity character string including verbs related to work activities. The memory 11 is an exemplary storage unit. For example, the computer 10 may use an external storage connected via a network in place of the memory 11. Such an exemplary variation also belongs to technical scope of the first embodiment.

Works handled by the tool selection method according to the first embodiment are, for example, works performed by a user using e-mail. The works handled by the tool selection method according to the first embodiment include, for example, announcement of a meeting, request to create material, ordering of a product, and the like.

An object character string may be exemplified by “meeting”, “material”, “product”, and the like. For example, works such as “announcement of a meeting” and “statement in a meeting” all have an object of “meeting”. Works such as “creation of material” or “distribution of material” all have an object of “material”. Works such as “ordering of a product” and “cancelling of a product” all have an object of “product”.

An activity character string may be exemplified by “announce”, “create”, “order”, “request”, and the like. The content of “work” is expressed by combining the activity character string and the object character string. As the work tool 16, there are, for example, e-mail, Web mail, a video conference system, a file sharing service, telephone, SNS (Social Networking Service), and the like.

The work tool 16 has an aptitude for work. For example, e-mail is a communication tool for communicating information from one person to one or more persons and thus suitable for notifying information. Video conference systems, on the other hand, are suitable for a situation in which a group of people gathers to have a discussion. Accordingly, the work tool 16 has an aptitude for work, and information indicating the aptitude is stored in the memory 11 as the attribute of the work tool 16.

The work models 13a and 13b are models expressing the content of “work” by a combination of information. The work model 13a includes “request” as an activity character string. In addition, the work model 13a includes, as a character string to be combined with “request”, an activity character string “discuss/ . . . /state” and an object character string “opinion/ . . . /question”. Here, “discuss/ . . . /state” in the drawing may correspond to any one of “discuss”, . . . , “state”. In addition, “opinion/ . . . /question” in the drawing may correspond to any one of “opinion”, . . . , “question”.

The work model 13b includes “request” as an activity character string. In addition, the work model 13b includes, as a character string to be combined with “request”, an activity character string “edit/ . . . /create” and an object character string “material/ . . . /document”. Here, “edit/ . . . /create” in the drawing may correspond to any one of “edit”, . . . , “create”. In addition, “material/ . . . /document” in the drawing may correspond to any one of “material”, . . . , “document”.

In the example of FIG. 1, the attribute of the work model 13a is set to a discussion type, and the attribute of the work model 13b is set to a cooperative type. The discussion type work model is associated with a discussion type communication tool. On the other hand, the cooperative type work model is associated with a cooperative type communication tool (not illustrated). The discussion type communication tool and the cooperative type communication tool are examples of the work tool 16.

The discussion type communication tool is a communication tool suitable for a work form in which a group of users has a discussion. A video conference system, for example, is conceivable as the discussion type communication tool. The cooperative type communication tool is a communication tool suitable for a work form in which a group of users cooperate to create a material. A communication tool combining web mail with a file sharing system, for example, is conceivable as the cooperative type communication tool.

The processor 12 detects a pair of an object character string and an activity character string from an e-mail 14, specifies the work model 13a corresponding to the detected pair, and specifies the work tool 16 having the attribute corresponding to the specified work model 13a.

Referring to the example of FIG. 1, from the character strings “request”, “opinion” and “state” described in the e-mail 14, “opinion” is detected as an object character string, and “state” is detected as an activity character string including a verb taking “opinion” as an object. In addition, “request” is detected as an activity character string including a verb taking “state opinion” as an object. Accordingly, an analysis result 15 including a sentence structure (relation among “opinion”, “state”, “request”) and elements of the structure is obtained by natural language processing.

In the example of FIG. 1, a work model corresponding to the sentence structure and the elements of the structure included in the analysis result 15 is the work model 13a. Therefore, the processor 12 selects the work model 13a corresponding to the detected character strings and verb described above. In addition, the processor 12 selects the work tool 16 having the attribute corresponding to the selected work model 13a. In the example of FIG. 1, the attribute of the work model 13a is the discussion type and thus the discussion type communication tool is selected. The selected discussion type communication tool is recommended to a user working using the e-mail 14, for example.

The first embodiment has thus been described above. Applying a program which realizes the aforementioned information processing using the computer and hardware resources of the computer 10 allows a communication tool suitable for the work to be selected with a high probability. As a method of providing the technique according to the first embodiment, there may also be conceived a method of providing a storage medium that is readable by the computer 10 and has the program stored therein.

### 2. Second Embodiment

Next, a second embodiment will be described.

### 2-1. System

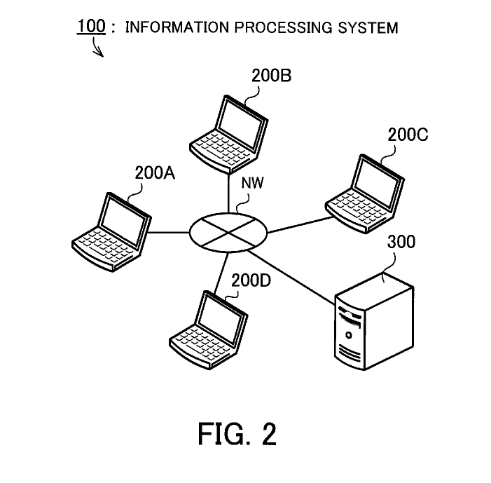

An information processing system 100 according to the second embodiment will be described, referring to FIG. 2. FIG. 2 illustrates an exemplary information processing system according to the second embodiment.

As illustrated in FIG. 2, the information processing system 100 includes terminal devices 200A, . . . , 200D, and a server device 300. In the following description, the terminal devices 200A, . . . , 200D may be simply referred to as the terminal device 200 without being distinguished from one another.

The terminal devices 200A, . . . , 200D are connected to the server device 300 via a network NW. The server device 300 provides the terminal devices 200A, . . . , 200D with a communication tool via the network NW.

For example, when the terminal device 200A makes an access using a Web browser or a dedicated browser (referred to as the browser in the following), the server device 300 provides the browser with a login screen of a unified system including a plurality of communication tools. When a user inputs authentication information to the login screen, the server device 300 obtains the authentication information from the terminal device 200A, and performs an authentication procedure by matching the user information being managed and the obtained authentication information. The authentication procedure may be performed using any method. When the authentication succeeds, the server device 300 provides the browser with the portal page of the unified system.

The portal page has arranged thereon a link button or the like for transitioning to the execution screen of the communication tool provided by the unified system, for example. The unified system includes communication tools such as e-mail, a file sharing system, a video conference system, telephone and SNS, for example. Furthermore, the unified system includes a notification type communication tool, a discussion type communication tool, a cooperative type communication tool, and the like. The type of communication tool provided by the unified system is set by a user or an administrator, for example. When a user selects a communication tool, the server device 300 provides the browser with the execution screen of the communication tool.

The server device 300 surveys the communication tool suitable for the work from the content of e-mail used by the user for work. Upon finding a communication tool which is more suitable for the work than e-mail, the server device 300 proposes the user to use the found communication tool. For example, when it is found from the content of e-mail that the user is about to have a discussion with other users, the server device 300 selects a video conference system or another discussion type communication tool as the communication tool suitable for discussion. The server device 300 then provides the browser with a screen for starting execution of the selected communication tool.

As thus described, the server device 300 has a mechanism that provides the function of the unified system to each of the terminal devices 200A, . . . , 200D and that recommends a communication tool which is suitable for the work from among the communication tools provided by the unified system. The mechanism allows a user working with the information processing system 100 to perform his/her work efficiently using a communication tool which is suitable for the work. For example, a user who has never used a communication tool other than e-mail may be encouraged to use a more preferred communication tool smoothly.

The information processing system 100 according to the second embodiment has thus been described above.

### 2-2. Communication Tool

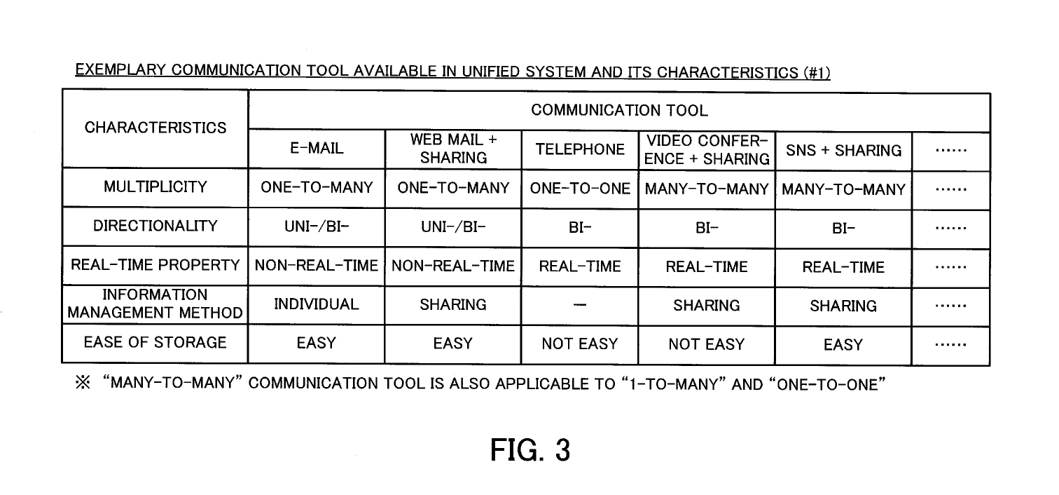

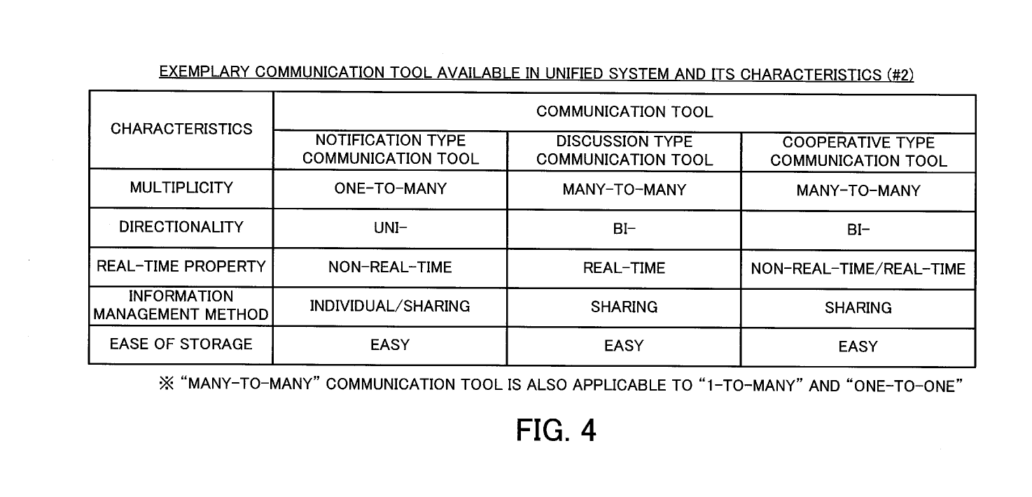

Next, communication tools which are applicable to an information processing system according to the second embodiment will be described, referring to FIGS. 3 and 4. FIG. 3 is a first drawing illustrating exemplary communication tools applicable to an information processing system according to the second embodiment, together with their characteristics. FIG. 4 is a second drawing illustrating exemplary communication tools applicable to the information processing system according to the second embodiment, together with their characteristics.

The unified system provided by the information processing system 100 is capable of handling various communication tools. For example, the unified system provides communication tools such as e-mail (including Web mail), a file sharing system, telephone, a video conference system and SNS. Furthermore, the unified system provides a flexible utilization form such as using the video conference system and the file sharing system in combination.

In the example of FIG. 3, “Web mail+sharing”, “Video conference+sharing”, and “SNS+sharing” correspond to the combined use. “Web mail+sharing” indicates a utilization form using Web mail and the file sharing system in combination. “Video conference+sharing” indicates a utilization form using the video conference system and the file sharing system in combination. “SNS+sharing” indicates a utilization form using SNS and the file sharing system in combination. For simplicity, “Web mail+sharing”, “Video conference+sharing”, and “SNS+sharing” will be simply denoted hereinafter as “Web mail”, “Video conference system”, and “SNS”, respectively, in the following.

Each communication tool has properties of its own. Here, characteristics such as “multiplicity”, “directionality”, “real-time property”, “information management method”, and “ease of storage” are considered as the property of a communication tool relating to its suitability to work.

“Multiplicity” is an index representing the suitable number of people on both sides of the communication using the communication tool. For example, e-mail is a communication tool which transmits information from one person to one or more persons. Accordingly, e-mail is not suitable for such use in which a group of people transmits information simultaneously. Therefore, the multiplicity of e-mail is “one-to-many”.

Note that, “one-to-many” indicates that the communication tool is suitable for communication between one person and a group of people, or between one person and one person. Similarly, the multiplicity of Web mail is “one-to-many”. The multiplicity of telephone is “one-to-one”. The multiplicity of a video conference system is “many-to-many”. “Many-to-many” indicates that the communication tool is suitable for communication between a group of people and a group of people, between one person and a group of people, or between one person and one person. The multiplicity of SNS is “many-to-many”.

“Directionality” is an index representing whether the communication performs one-way information transmission (referred to as uni-directional communication in the following description) or accompanies information exchange (referred to as bi-directional communication in the following). For example, uni-directional communication is a type of communication that does not request a response from the opposite party. Bi-directional communication, on the other hand, is a type of communication that somehow requests a response from the opposite party. In the case of telephone, for example, conversation is not established unless there is a response from the opposite party. Therefore, the directionality of telephone is “bi-directional”.

In the example of FIG. 3, uni-directional communication is denoted as “uni-”, and bi-directional communication is denoted as “bi-”. In addition, characteristics denoted as “uni-/bi-” indicate that the communication tool is available for both uni-directional communication and bi-directional communication. For example, the directionality of e-mail is “uni-/bi-”, the directionality of Web mail is “uni-/bi-”, the directionality of a video conference system is “bi-”, and the directionality of SNS is “bi-”.

“Real-time property” is an index representing whether or not it is suitable for one party and the other party involved in the communication to exchange information with each other in real-time. In the case of e-mail, for example, the timing of reading or responding to an e-mail is determined at the convenience of the other party. Therefore, the real-time property of e-mail is “non-real-time”. “Non-real-time” indicates that the communication tool is not suitable for communication which requires real-time property. Telephone, on the other hand, is a communication tool that provides audio communication in a state being connected to the other party via a network. Therefore, the real-time property of telephone is “real-time”. “Real-time” indicates that the communication tool is suitable for communication which requires real-time property.

“Information management method” is an index representing how information such as a data file is managed. For example, when an e-mail is transmitted with a data file attached thereto, the data file is individually managed by each user who received the e-mail. Therefore, the “information management method” of e-mail is “individual”. In the case of Web mail, on the other hand, a file sharing system is used in conjunction therewith and thus a user participating in communication is allowed to share a data file using the file sharing system. Therefore, the “information management method” of Web mail is “sharing”. Since telephone is based on audio communication, the data file management method is not taken into account here.

“Ease of storage” is an index representing the degree of ease to store information exchanged in the course of communication. With e-mail, for example, information exchanged in the course of communication may be easily stored since texts remain in the e-mail client or the e-mail server. Therefore, the “ease of storage” of e-mail is “easy”. With telephone, on the other hand, storing information exchanged in the course of communication is not easy in comparison with e-mail, although it is possible to record the conversation using an audio recorder or the like. Therefore, the “ease of storage” of telephone is “not easy”.

As thus described, each communication tool has properties of its own. The property of a communication tool and its suitability to work are closely related to each other. For example, it is difficult to use telephone, whose multiplicity is “one-to-one”, for a work in which many users have a free discussion. On the other hand, when it is desired to promptly contact a particular counterpart, telephone which is “real-time” in the real-time property is a suitable communication tool.

Although FIG. 3 illustrates a commonly used communication tool, the unified system may have a built-in communication tool having set therein properties according to the type of work, as illustrated in FIG. 4. FIG. 4 illustrates properties of a notification type communication tool, a discussion type communication tool, and a cooperative type communication tool.

The notification type communication tool is an exemplary communication tool which is suitable for the work of notifying information. The discussion type communication tool is a communication tool which is suitable for the work in which many users gather in one place to have a discussion. The cooperative type communication tool is a communication tool which is suitable for the work such as editing a single data file by a group of people.

The characteristics of the notification type communication tool are such that the multiplicity is “one-to-many”, the directionality is “uni-”, the real-time property is “non-real-time”, the information management method is “individual/sharing”, and the ease of storage is “easy”. Here, “individual/sharing” indicates that either of “individual” and “sharing” is allowed. The characteristics of the discussion type communication tool are such that the multiplicity is “many-to-many”, the directionality is “bi-”, the real-time property is “real-time”, the information management method is “sharing”, and the ease of storage is “easy”.

The characteristics of the cooperative type communication tool are such that the multiplicity is “many-to-many”, the directionality is “bi-”, the real-time property is “non-real-time/real-time”, the information management method is “sharing”, and the ease of storage is “easy”. Here, “non-real-time/real-time” indicates that either of “non-real-time” and “real-time” is allowed. As thus described, preliminarily preparing the communication tool assuming the type of work may widen the choice. In the following description, it is assumed that unified system provided by the server device 300 has built therein the communication tool illustrated in FIGS. 3 and 4.

The communication tool applicable to the information processing system according to the second embodiment has thus been described above.

### 2-3. Hardware

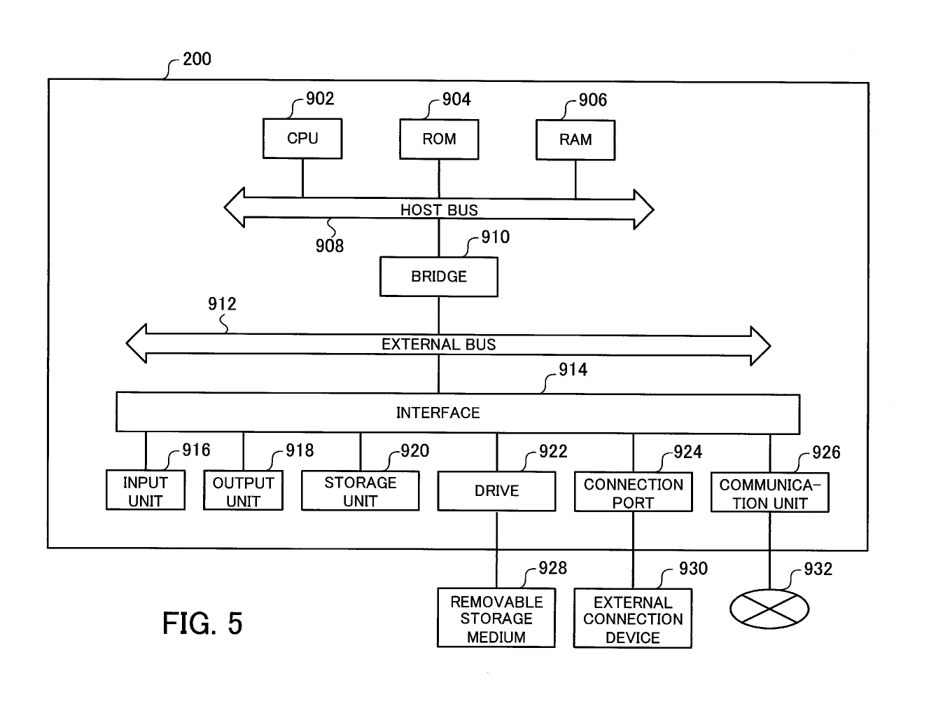

Hardware of the terminal device 200 according to the second embodiment will be described, referring to FIG. 5. The function included in the terminal device 200 may be realized by hardware resources of the information processor illustrated in FIG. 5, for example. In other words, the function included in the terminal device 200 is realized by controlling the hardware illustrated in FIG. 5 using a computer program. FIG. 5 illustrates an example of hardware capable of realizing the function of the terminal device according to the second embodiment.

As illustrated in FIG. 5, this hardware has, as main components, a CPU 902, a ROM (Read Only Memory) 904, a RAM 906, a host bus 908, and a bridge 910. Furthermore, the hardware has an external bus 912, an interface 914, an input unit 916, an output unit 918, a storage unit 920, a drive 922, a connection port 924, and a communication unit 926.

The CPU 902 functions as an arithmetic processing unit or a control unit, for example, and controls all or a part of the operation of each component based on various programs stored in the ROM 904, the RAM 906, the storage unit 920, or a removable storage medium 928. The ROM 904 is an exemplary storage device which stores a program to be read into the CPU 902 or data to be used for calculation. The RAM 906 has temporarily or permanently stored therein a program to be read into the CPU 902 or various parameters that vary when the program is executed, for example.

These components are connected to one another via the host bus 908 capable of high-speed data transmission, for example. The host bus 908, on the other hand, is connected to an external bus 912 having a relatively low data transmission speed via the bridge 910, for example. In addition, a mouse, a keyboard, a touch panel, a touchpad, a button, a switch, a lever or the like, for example, is used as the input unit 916. Furthermore, a remote controller capable of transmitting control signals using infrared rays or other electric waves may also be used as the input unit 916.

A display unit such as a CRT (Cathode Ray Tube), an LCD (Liquid Crystal Display), a PDP (Plasma Display Panel), an ELD (Electro-Luminescence Display), for example, is used as the output unit 918. In addition, an audio output device such as a loud speaker or a headphone, or a printer may also be used as the output unit 918. In other words, the output unit 918 is a device capable of outputting information visually or audibly.

The storage unit 920 is a device for storing various data. A magnetic storage device such as an HDD, for example, is used as the storage unit 920. In addition, a semiconductor storage device such as an SSD (Solid State Drive) or a RAM disk, an optical storage device, or a magneto-optical storage device may also be used as the storage unit 920.

The drive 922 is a device which reads information stored in a removable storage medium 928, which is an attachable and detachable storage medium, or writes information to the removable storage medium 928. A magnetic disk, an optical disk, a magneto-optical disk, a semiconductor memory or the like, for example, is used as the removable storage medium 928.

The connection port 924 is a port for connecting an external connection device 930 such as, for example, a USB (Universal Serial Bus) port, an IEEE 1394 port, SCSI (Small Computer System Interface), an RS-232C port, an optical audio terminal or the like. A printer or a camera, for example, is used as the external connection device 930.

The communication unit 926 is a communication device for connecting to a network 932. A communication circuit for a wired or wireless LAN (Local Area Network), a communication circuit for a WUSB (Wireless USB), a communication circuit or a router for optical communication, a communication circuit or router for ADSL (Asymmetric Digital Subscriber Line), or a communication circuit for a mobile phone network, for example, is used as the communication unit 926. The network 932 connected to the communication unit 926 is a network connected in a wired or wireless manner and including, for example, the Internet, a LAN, a broadcast network, a satellite communication link, or the like.

The hardware of the terminal device 200 according to the second embodiment has thus been described above. The function included in the server device 300 may also be realized using the hardware illustrated in FIG. 5. Therefore, detailed description of the hardware capable of realizing the function included in the server device 300 is omitted.

### 2-4. Function of Server Device

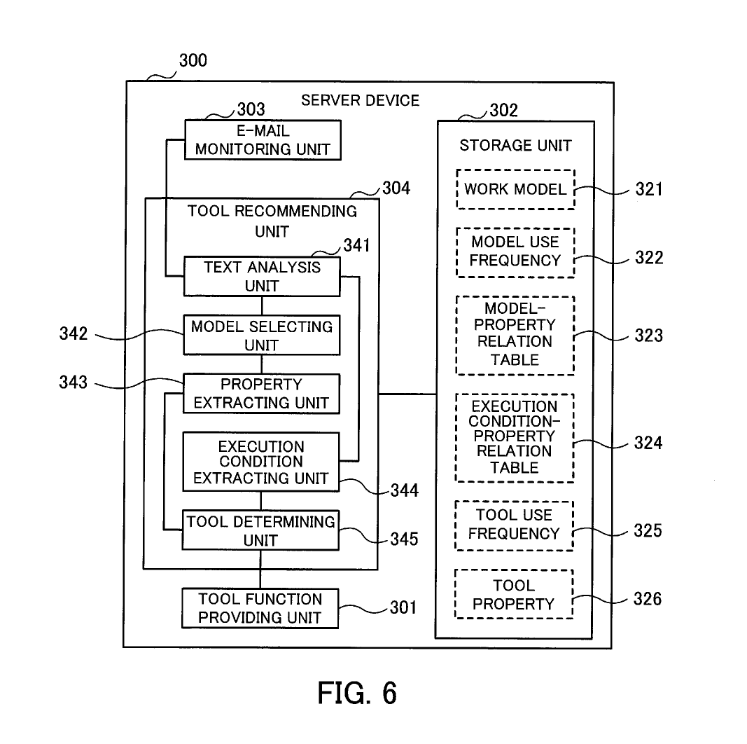

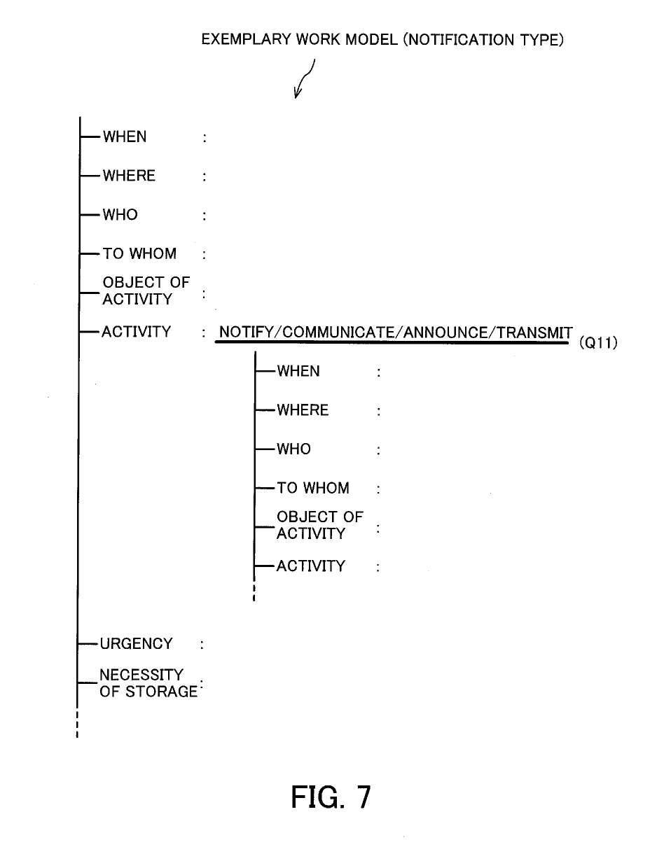

Next, a function of the server device 300 according to the second embodiment will be described, referring to FIG. 6. FIG. 6 is a block diagram illustrating an exemplary function included in the server device according to the second embodiment. In the description, reference will be made to FIGS. 7 to 18 as appropriate.

As illustrated in FIG. 6, the server device 300 has a tool function providing unit 301, a storage unit 302, an e-mail monitoring unit 303, and a tool recommending unit 304. The functions of the tool function providing unit 301, the e-mail monitoring unit 303, and the tool recommending unit 304 may be realized using the CPU 902 and the like. In addition, the function of the storage unit 302 may be realized using the aforementioned RAM 906, the storage unit 920, or the like.

[Tool Function Providing Unit 301]

The tool function providing unit 301 will be described below.

The tool function providing unit 301 executes the communication tool selected by the user. In addition, the tool function providing unit 301 provides the browser with an execution screen of the communication tool. When the user has selected an e-mail, for example, the tool function providing unit 301 provides the browser with an e-mail editing screen or the like. In addition, when the user has performed a transmission operation, the tool function providing unit 301 performs an e-mail transmission process.

In addition, the tool function providing unit 301 provides the browser with a screen for activating the communication tool selected by the tool recommending unit 304 described below. When the user performs the activation operation, the tool function providing unit 301 provides the browser with an execution screen of the communication tool. As thus described, the tool function providing unit 301 is an element to provide the user with the function of the communication tool via the browser.

[Storage Unit 302]

The storage unit 302 will be described.

The storage unit 302 has stored therein a work model 321, a model use frequency 322, a model-property relation table 323, an execution condition-property relation table 324, a tool use frequency 325, and a tool property 326. In the following, the work model 321, the model use frequency 322, the model-property relation table 323, the execution condition-property relation table 324, the tool use frequency 325, and the tool property 326 will be described in order.

(Work Model 321)

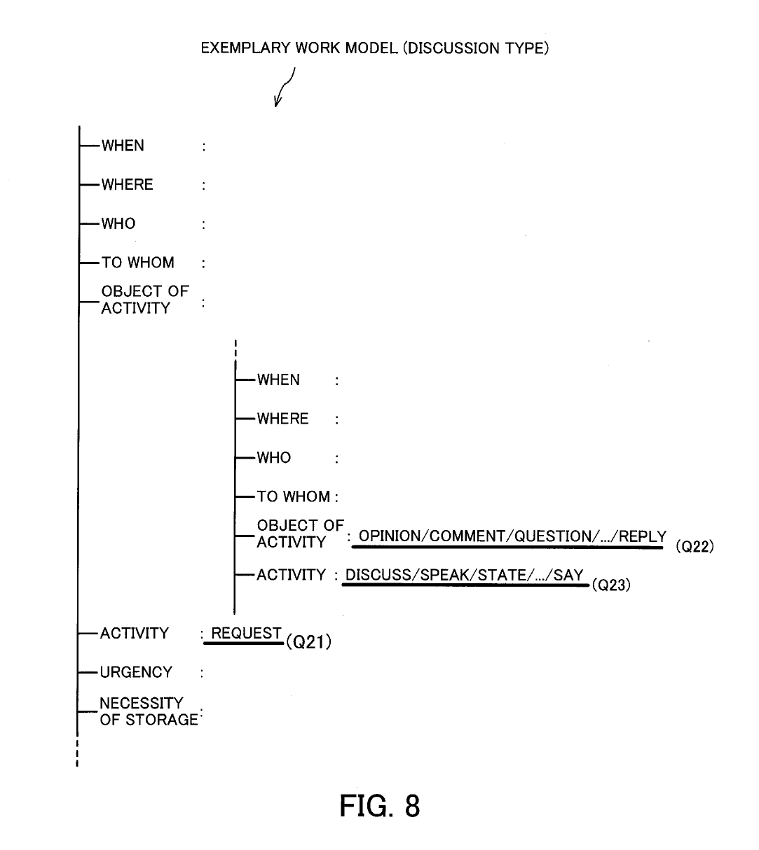

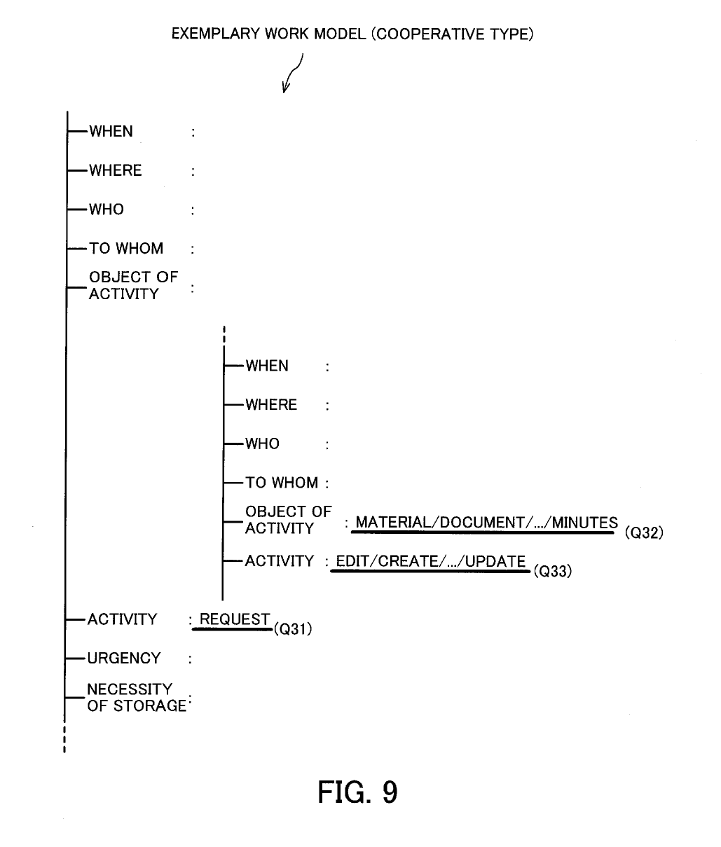

First, the work model 321 will be described, referring to FIGS. 7 to 9. FIG. 7 illustrates an exemplary (notification type) work model being used by the server device according to the second embodiment. FIG. 8 illustrates an exemplary (discussion type) work model being used by the server device according to the second embodiment. FIG. 9 illustrates an exemplary (cooperative type) work model being used by the server device according to the second embodiment.

The work model 321 has a structure defined by a plurality of terms and a relation between the terms, with a group of words associated with a part or all of the terms. A term with which a group of words is associated, and a group of words associated with a term are determined for each type of work.

(Notification Type)

In the case of a notification type work, for example, the work model 321 such as that illustrated in FIG. 7 is applied. In the example of FIG. 7, “when”, “where”, “who”, “to whom”, “object of activity”, “activity”, and the like are used as terms of the work model 321. Additionally, in the example of FIG. 7, “urgency”, “necessity of storage”, and the like are used as terms of the work model 321.

The notification type work model 321 has set therein a group of verbs “notify/communicate/announce/transmit” in the “activity” term (code Q11 of FIG. 7). Here, “notify/communicate/announce/transmit” indicates that it corresponds to any one of “notify”, “communicate”, “announce”, and “transmit”.

When natural language processing is performed on a text described by a user engaged in a notification type work, it is highly likely that a word corresponding to the term “activity” falls on any one of “notify”, “communicate”, “announce” and “transmit”. Modeling the aforementioned idea results in the notification type work model 321 illustrated in FIG. 7.

The work model 321 illustrated in FIG. 7 is an exemplary notification type work model. Setting of the work model 321 may be manually performed based on an empirical rule, or may be automatically performed by collecting texts described by a user engaged in a notification type work and analyzing the content of description using a statistical technique.

(Discussion Type)

In the case of a discussion type work, the work model 321 such as that illustrated in FIG. 8 is applied. In the example of FIG. 8, “when”, “where”, “who”, “to whom”, “object of activity”, “activity”, and the like are used as terms of the work model 321, similarly to the notification type. Additionally, in the example of FIG. 8, “urgency”, “necessity of storage”, and the like are used as terms of the work model 321.

The discussion type work model 321 has a verb “request” associated with the term “activity” (code Q21 of FIG. 8). In addition, terms such as “when”, “where”, “who”, “to whom”, “object of activity”, “activity” are associated with the verb “request” to form an objective phrase thereof. The term “object of activity” (code Q22 of FIG. 8) forming the phrase is associated with a group of nouns “opinion/comment/question/ . . . /reply”. Furthermore, one of the verbs “discuss/speak/state/ . . . /say” which takes any of the group of nouns as an object is associated with the term “activity” (code Q23 of FIG. 8).

Here, “opinion/comment/question/ . . . /reply” indicates that it corresponds to any one of “opinion”, “comment”, “question”, . . . , and “reply”. In addition, “discuss/speak/state/ . . . /say” indicates that it corresponds to any one of “discuss”, “speak”, “state”, . . . , and “say”.

When natural language processing is performed on a text described by a user engaged in a discussion type work, it is highly likely that a word corresponding to the term “activity” (code Q21 of FIG. 8) falls on “request”. In addition, it is highly likely that the term “object of activity” (code Q22 of FIG. 8) forming an objective phrase of the verb “request” falls on any one of “opinion”, “comment”, “question”, . . . , and “reply”. In addition, it is highly likely that the term “activity” (code Q23 of FIG. 8) forming the phrase falls on any one of “discuss”, “speak”, “state”, . . . , and “say”.

Modeling the aforementioned idea results in the discussion type work model 321 illustrated in FIG. 8. The work model 321 illustrated in FIG. 8 is an exemplary discussion type work model. As with the notification type, setting of the work model 321 may be manually performed based on an empirical rule, or may be automatically performed by collecting texts described by a user engaged in a discussion type work and analyzing the content of description using a statistical technique.

(Cooperative Type)

In the case of a cooperative type work, the model 321 such as that illustrated in FIG. 9 is applied. In the example of FIG. 9, “when”, “where”, “who”, “to whom”, “object of activity”, “activity” and the like are used as terms of the work model 321, similarly to the notification type. Additionally, in the example of FIG. 9, “urgency”, “necessity of storage”, and the like are used as terms of the work model 321.

The cooperative type work model 321 has set therein a verb “request” associated with the term “activity” (code Q31 of FIG. 9). In addition, terms such as “when”, “where”, “who”, “to whom”, “object of activity”, “activity” are associated with the verb “request” to form an objective phrase thereof. The term “object of activity” (code Q32 of FIG. 9) forming the phrase is associated with a group of nouns “material/document/ . . . /minutes”. Furthermore, one of the verbs “edit/create/ . . . /update” which takes one of the group of nouns as an object is associated with the term “activity” (code Q33 of FIG. 9).

Here “material/document/ . . . /minutes” indicates that it corresponds to any one of “material”, “document”, . . . , and “minutes”. In addition, “edit/create/ . . . /update” indicates that it corresponds to any one of “edit”, “create”, . . . , and “update”.

When natural language processing is performed on a text described by a user engaged in a cooperative type work, it is highly likely that a word corresponding to the term “activity” (code Q31 of FIG. 9) falls on “request”. In addition, it is highly likely that the term “object of activity” (code Q32 of FIG. 9) forming an objective phrase of the verb “request” falls on any one of “material”, “document”, . . . , “minutes”. In addition, it is highly likely that the term “activity” (code Q33 of FIG. 9) forming the phrase falls on any one of “edit”, “create”, . . . , and “update”.

Modeling the aforementioned idea results in the cooperative type work model 321 illustrated in FIG. 9. The work model 321 illustrated in FIG. 9 is an exemplary cooperative type work model. As with the notification type, setting of the work model 321 may be manually performed based on an empirical rule, or may be automatically performed by collecting texts described by a user engaged in a cooperative type work and analyzing the content of description using a statistical technique.

(Model Use Frequency 322)

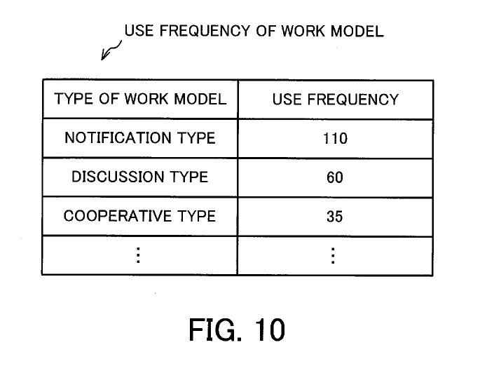

Next, the model use frequency 322 will be described, referring to FIG. 10. FIG. 10 illustrates an example of information indicating the use frequency of the work model being used by the server device according to the second embodiment.

The model use frequency 322 is information indicating the use frequency of the work model 321 for each type of work. As illustrated in FIG. 10, the model use frequency 322 is associated with a numerical value indicating the use frequency of the work model 321 for each of the notification, discussion, and cooperative types. The numerical value indicating the use frequency may be, for example, the number of times the work model 321 is used, or the number of times a communication tool selected using the work model 321 is used by a user. The model use frequency 322 is referred to in selection of the work model 321.

(Model-Property Relation Table 323)

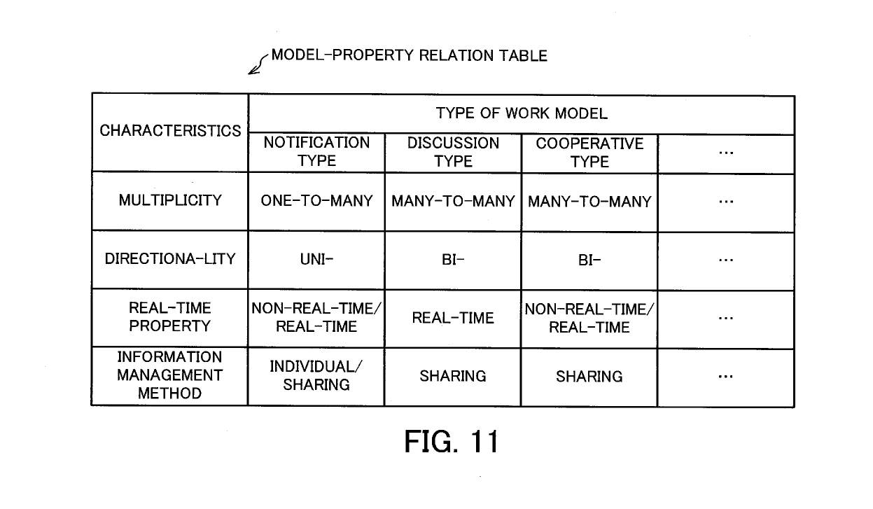

Next, the model-property relation table 323 will be described, referring to FIG. 11. FIG. 11 illustrates an exemplary model-property relation table used by the server device according to the second embodiment.

The model-property relation table 323 holds information describing the relation between the work model 321 and the property of the communication tool in association with each type of work. In the model-property relation table 323 illustrated in FIG. 11, “multiplicity”, “directionality”, “real-time property”, and “information management method” are taken into account as the characteristics of the communication tool. It is also possible to take into account the characteristics of a communication tool which is not illustrated here.

It is known from the model-property relation table 323 of FIG. 11 that the notification type work model 321 is associated with properties such that the multiplicity is “one-to-many”, the directionality is “uni-”, the real-time property is “non-real-time/real-time”, and the information management method is “individual/sharing”. Here, “non-real-time/real-time” indicates that either one of “non-real-time” and “real-time” is allowed.

In addition, it is known from the model-property relation table 323 of FIG. 11 that the discussion type work model 321 is associated with properties such that the multiplicity is “many-to-many”, the directionality is “bi-”, the real-time property is “real-time”, and the information management method is “sharing”. Furthermore, it is known that the cooperative type work model 321 is associated with properties such that the multiplicity is “many-to-many”, the directionality is “bi-”, the real-time property is “non-real-time/real-time”, and the information management method is “sharing”. The model-property relation table 323 is referred to in selection of a communication tool corresponding to the work model 321.

(Execution Condition-Property Relation Table 324)

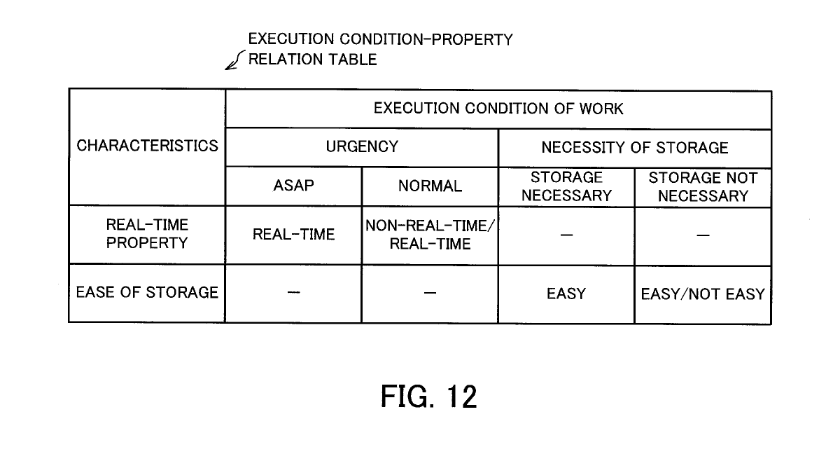

Next, the execution condition-property relation table 324 will be described, referring to FIG. 12. FIG. 12 illustrates an exemplary execution condition-property relation table used by the server device according to the second embodiment.

The execution condition-property relation table 324 holds information describing the correspondence between the execution condition of a work and the property of the communication tool. In the execution condition-property relation table 324 illustrated in FIG. 12, “real-time property” and “ease of storage” are taken into account as characteristics of the communication tool. It is also possible to take into account the characteristics of a communication tool which is not illustrated here.

Additionally, in the example of FIG. 12, “urgency” and “necessity of storage” are set as the execution condition of the work. “Urgency” is a term representing whether or not to perform the work in a hurry. “Necessity of storage” is a term representing whether or not to store the information exchanged during execution of the work. The determination method of “urgency” and “necessity of storage” will be described below.

Referring to the execution condition-property relation table 324 of FIG. 12, it is known that a condition (property) with the real-time property being “real-time” is associated with an execution condition with the urgency being “urgent”. On the other hand, it is known that a condition (property) with the real-time property being “non-real-time/real-time” is associated with the execution condition with the urgency being “normal”.

In addition, it is known that an execution condition with the necessity of storage being “storage necessary” is associated with a condition (property) with the ease of storage being “easy”. On the other hand, it is known that an execution condition with the necessity of storage being “storage not necessary” is associated with a condition (property) with the ease of storage being “easy/not easy”. The execution condition-property relation table 324 is referred to in selection of a communication tool satisfying the execution condition.

(Tool Use Frequency 325)

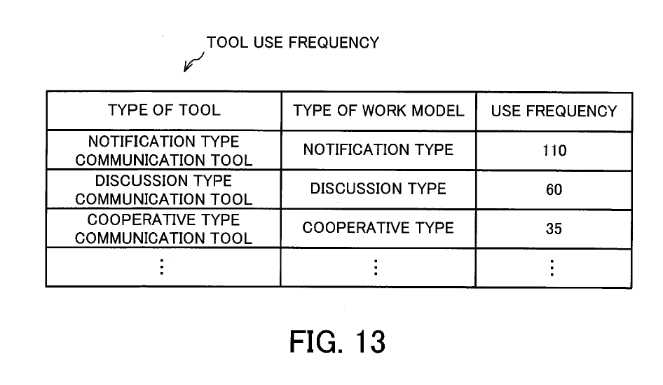

Next, the tool use frequency 325 will be described, referring to FIG. 13. FIG. 13 illustrates an example of information indicating the use frequency of the communication tool being used by the server device according to the second embodiment.

The tool use frequency 325 is information indicating the use frequency of the communication tool. As illustrated in FIG. 13, for example, the tool use frequency 325 is associated with a numerical value indicating the use frequency for each type of communication tools such as the notification type communication tool, the discussion type communication tool, the cooperative type communication tool, and the like. The numerical value indicating the use frequency is, for example, the number of times the communication tool is used by the user.

The use frequency may be associated with a combination of the type of the communication tool and the type of the work model 321 (type of work) used in selection of the communication tool, as illustrated in FIG. 13. The tool use frequency 325 is referred to in selection of the communication tool.

(Tool Property 326)

Next, the tool property 326 will be described. The tool property 326 is information associating the type of the communication tool with the property of the communication tool. For example, the information illustrated in FIGS. 3 and 4 is an example of the tool property 326.

Referring to FIG. 4, for example, a notification type communication tool has properties such that the multiplicity is “one-to-many”, the directionality is “uni-”, the real-time property is “non-real-time”, the information management method is “individual/sharing”, and the ease of storage is “easy”. A discussion type communication tool has properties such that the multiplicity is “many-to-many”, the directionality is “bi-”, the real-time property is “real-time”, the information management method is “sharing”, and the ease of storage is “easy”.

In addition, a cooperative type communication tool has properties such that the multiplicity is “many-to-many”, the directionality is “bi-”, the real-time property is “non-real-time/real-time”, the information management method is “sharing”, and the ease of storage is “easy”. The tool property 326 is referred in determination of a communication tool which is suitable for work.

[E-Mail Monitoring Unit 303]

The e-mail monitoring unit 303 will be described. FIG. 6 will be referred to again.

The e-mail monitoring unit 303 is a component configured to monitor e-mails created by the user. For example, the e-mail monitoring unit 303 obtains a text of an e-mail at the timing when the user performs an operation to transmit the e-mail. The timing of obtaining texts of an e-mail may be at transmission of the e-mail, or after transmission of the e-mail.

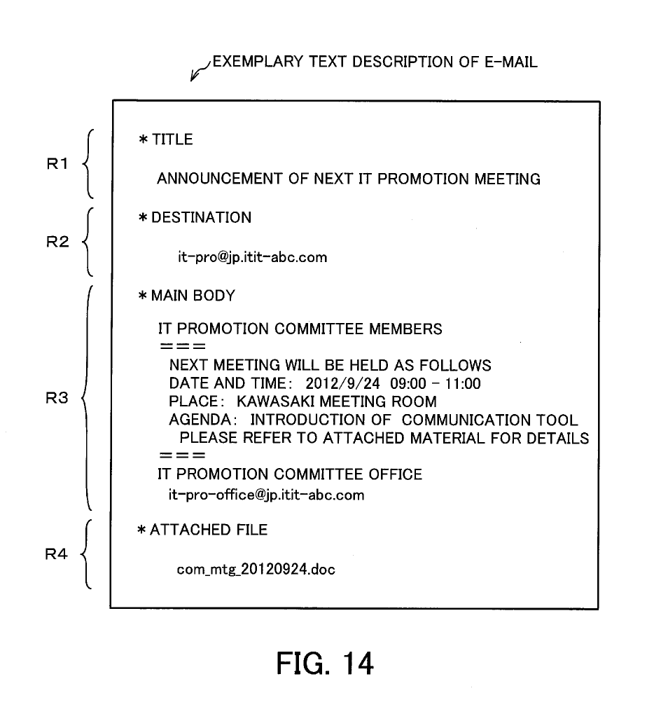

For example, the e-mail monitoring unit 303 obtains a text of an e-mail such as that illustrated in FIG. 14. FIG. 14 illustrates an exemplary text description of an e-mail to be processed by the server device according to the second embodiment. The text illustrated in FIG. 14 includes a title R1, a destination R2, a main body R3, and an attached file name R4. Having obtained an e-mail, the e-mail monitoring unit 303 inputs the text of the obtained e-mail to the tool recommending unit 304.

[Tool Recommending Unit 304]

The tool recommending unit 304 will be described. FIG. 6 will be referred to again.

The tool recommending unit 304 includes a text analysis unit 341, a model selecting unit 342, a property extracting unit 343, an execution condition extracting unit 344, and a tool determining unit 345.

(Text Analysis Unit 341)

A text of an e-mail is input to the text analysis unit 341 from the e-mail monitoring unit 303. Having received the text, the text analysis unit 341 performs natural language processing on the input text such as morphological analysis or syntax analysis to analyze the content of the text.

For example, the text analysis unit 341 analyzes the text structure by natural language processing and extracts a character string (work element, in the following) applicable to a term which is a component of the set structure. The text analysis unit 341 then applies the extracted work element to the structure. The structure to which the work element is applied is set identically to the structure of the work model 321. In addition, the structure having a work element applied thereto is referred to as a work instance segment.

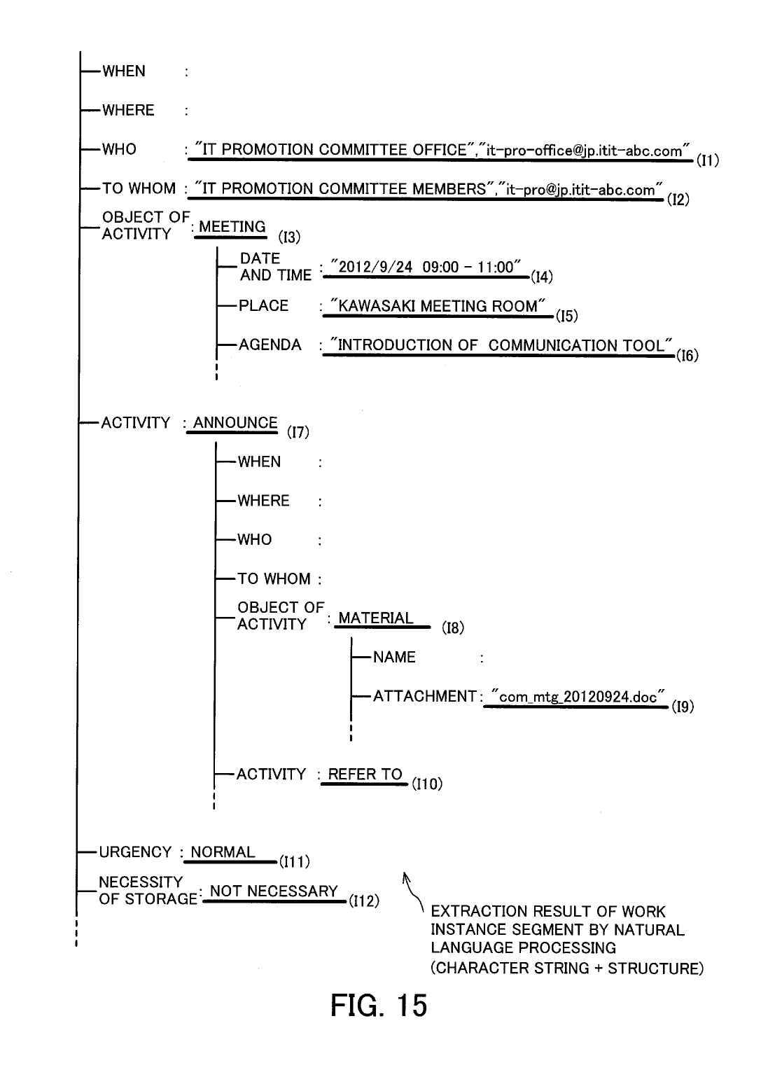

Upon input of the e-mail text illustrated in FIG. 14, the text analysis unit 341 extracts the work element based on the natural language processing and, as illustrated in FIG. 15, applies the extracted work element to a corresponding term. FIG. 15 illustrates an exemplary work instance segment extracted from an e-mail by the server device according to the second embodiment.

Performing morphological analysis and syntax analysis on the title R1 (see FIG. 14) allows a verb “announce” and its object “meeting” to be extracted. The text analysis unit 341 then applies “announce” to the term “activity” (code I7 of FIG. 15) and applies “meeting” to the term “object of activity” (code I3 of FIG. 15). Similarly, the text analysis unit 341 analyzes the destination R2 and the main body R3 (see FIG. 14) and applies “IT promotion committee office” and “it-pro-office@jp.itit-abc.com” extracted from the text to the term “who” (code I1 of FIG. 15).

In addition, the text analysis unit 341 analyzes the destination R2 and the main body R3 (see FIG. 14) and applies “IT promotion committee members” and “it-pro@jp.itit-abc.com” extracted from the text to the term “to whom” (code I2 of FIG. 15). Furthermore, the text analysis unit 341 applies “2012/9/24 09:00-11:00”, “Kawasaki meeting room”, and “introduction of communication tool” extracted from the text to the terms “date and time”, “place”, and “agenda” (codes I4, I5 and I6 of FIG. 15), respectively.

In addition, the text analysis unit 341 analyzes the main body R3 (see FIG. 14) and applies “material” extracted from the text to the term “object of activity” (code I8 of FIG. 15). Furthermore, the text analysis unit 341 analyzes the attached file name R4 (see FIG. 14) and applies “com_mtg_{—}20120924.doc” extracted from the text to the term “attachment” (code I9 of FIG. 15).

In addition, the text analysis unit 341 extracts a character string expressing urgency such as “ASAP”, “hurry”, and “urgent” from the text of the title R1 and the main body R3 (see FIG. 14). When a character string expressing such urgency is extracted, the text analysis unit 341 sets the term “urgency” (code I11 of FIG. 15) to “ASAP”. When, on the other hand, no character string expressing urgency is extracted, the text analysis unit 341 extracts a character string expressing a time limit such as “due date/time”, “deadline” or the like from the text of the title R1 and the main body R3 (see FIG. 14).

When a character string expressing such a time limit is extracted, the text analysis unit 341 detects the character string expressing the due date/time. The text analysis unit 341 then calculates the time from the present time to the due date/time, and determines whether or not the calculated time is equal to or shorter than a predetermined threshold. When the calculated time is equal to or shorter than the threshold, the text analysis unit 341 sets the term “urgency” (code I11 of FIG. 15) to “ASAP”. When, on the other hand, the calculated time is more than the threshold, the text analysis unit 341 sets the term “urgency” (code I11 of FIG. 15) to “normal”. In addition, the text analysis unit 341 sets the term “urgency” (code I11 of FIG. 15) to “normal” also when no character string expressing a time limit is extracted.

In addition, the text analysis unit 341 extracts a character string expressing significance such as “important” or “necessary . . . ” from the text of the title R1 and the main body R3 (see FIG. 14). When a character string expressing such significance is extracted, the text analysis unit 341 sets the term “necessity of storage” (code I12 of FIG. 15) to “necessary”. When, on the other hand, no character string expressing significance is extracted, the text analysis unit 341 sets the term “necessity of storage” (code I12 of FIG. 15) to “not necessary”. The work instance segment generated by the text analysis unit 341 in this manner is input to the model selecting unit 342 and the execution condition extracting unit 344.

(Model Selecting Unit 342)

FIG. 6 will be referred to again. The work instance segment extracted by the text analysis unit 341 is input to the model selecting unit 342. The model selecting unit 342 refers to the work model 321 and the model use frequency 322 stored in the storage unit 302, and selects the work model 321 corresponding to the input work instance segment.

First, the model selecting unit 342 refers to the work model 321 stored in the storage unit 302 and checks the term having a group of words set thereto. Subsequently, the model selecting unit 342 extracts a work element applied to the work instance segment for the same term as the term having a group of words set thereto in the work model 321.

Subsequently, the model selecting unit 342 determines whether or not the extracted work element corresponds to any one of the group of words which is set to the work model 321. Similarly, the model selecting unit 342 performs a determination procedure for all the terms of the work model 321 to which the group of words is set and, when it is determined that all the terms correspond, selects the work model 321 as a candidate.

For example, there is considered a case where the work instance segment illustrated in FIG. 15 is input. For example, the model selecting unit 342 refers to the notification type work model 321 illustrated in FIG. 7. The notification type work model 321 illustrated in FIG. 7 has a group of words “notify/communicate/announce/transmit” set in the term of code Q11.

The model selecting unit 342 extracts a work element “announce” from the term (code I7 of FIG. 15) of the work instance segment corresponding to the term of the code Q11. The model selecting unit 342 then determines whether or not the extracted work element “announce” is included in a group of words “notify/communicate/announce/transmit”. In this case, the work element “announce” is included in the group of words “notify/communicate/announce/transmit”.

The term of the code Q11 is the only term having a group of words set thereto in the work model 321 illustrated in FIG. 7. Therefore, the model selecting unit 342 selects the notification type work model 321 illustrated in FIG. 7 as a candidate of the work model 321 corresponding to the work instance segment. Similarly, the model selecting unit 342 also determines whether or not the work model 321 illustrated in FIGS. 8 and 9 may become a candidate of the work model 321 corresponding to the work instance segment.

The work model 321 illustrated in FIGS. 8 and 9 is not selected as a candidate of the work model 321 corresponding to the work instance segment illustrated in FIG. 15. However, a candidate of the work model 321 corresponding to the work instance segment illustrated in FIG. 15 may also be selected besides the notification type work model 321 illustrated in FIG. 7.

In this case, the model selecting unit 342 refers to the model use frequency 322 (for example, FIG. 10) stored in the storage unit 302 and selects one of the work models 321 from among the candidates. For example, the model selecting unit 342 selects the work model 321 with the highest use frequency. Note that, when the number of work models 321 selected as a candidate is one, the model selecting unit 342 outputs the selected work model 321 as the final selection result. The work model 321 selected by the model selecting unit 342 is input to the property extracting unit 343.

(Property Extracting Unit 343)

FIG. 6 will be referred to again. The property extracting unit 343 extracts the property of the communication tool corresponding to the work model 321 selected by the model selecting unit 342. In this occasion, the property extracting unit 343 uses model-property relation table 323 stored in the storage unit 302. For example, when the work model 321 selected by the model selecting unit 342 is the notification type work model 321, the property extracting unit 343 extracts the property of the communication tool corresponding to the notification type, from the model-property relation table 323 illustrated in FIG. 11. In this case, properties such that the multiplicity is “one-to-many”, the directionality is “uni-”, the real-time property is “non-real-time/real-time”, and the information management method is “individual/sharing” are extracted. The properties extracted by the property extracting unit 343 are input to the tool determining unit 345.

(Execution Condition Extracting Unit 344)

The execution condition extracting unit 344 extracts the execution condition corresponding to the work instance segment input from the text analysis unit 341. Furthermore, the execution condition extracting unit 344 extracts the property of the communication tool satisfying the extracted execution condition.

For example, when the work instance segment illustrated in FIG. 15 is input, the execution condition extracting unit 344 refers to the work element which is set to the term “urgency” (code I11 of FIG. 15). In the example of FIG. 15, the urgency is set to “normal”. Furthermore, the execution condition extracting unit 344 refers to the work element which is set to the term “necessity of storage” (code I12 of FIG. 15). In the example of FIG. 15, necessity of storage is set to “not necessary”.

Subsequently, the execution condition extracting unit 344 refers to the execution condition-property relation table 324 stored in the storage unit 302 (see FIG. 12) and extracts the property of the communication tool in the case where the urgency is set to “normal” and the necessity of storage is set to “not necessary”. In this case, the execution condition extracting unit 344 extracts the properties of the communication tool such that the real-time property is “non-real-time/real-time” and the ease of storage is “easy/not easy”. The property extracted by the execution condition extracting unit 344 is input to the tool determining unit 345.

(Tool Determining Unit 345)

The tool determining unit 345 combines the properties of the communication tool which are input from the property extracting unit 343 and the properties of the communication tool which are input from the execution condition extracting unit 344, to generate an extraction condition of the communication tool. The tool determining unit 345 then determines a communication tool satisfying the generated extraction condition. In this occasion, the tool determining unit 345 uses the tool use frequency 325 and the tool property 326 stored in the storage unit 302.

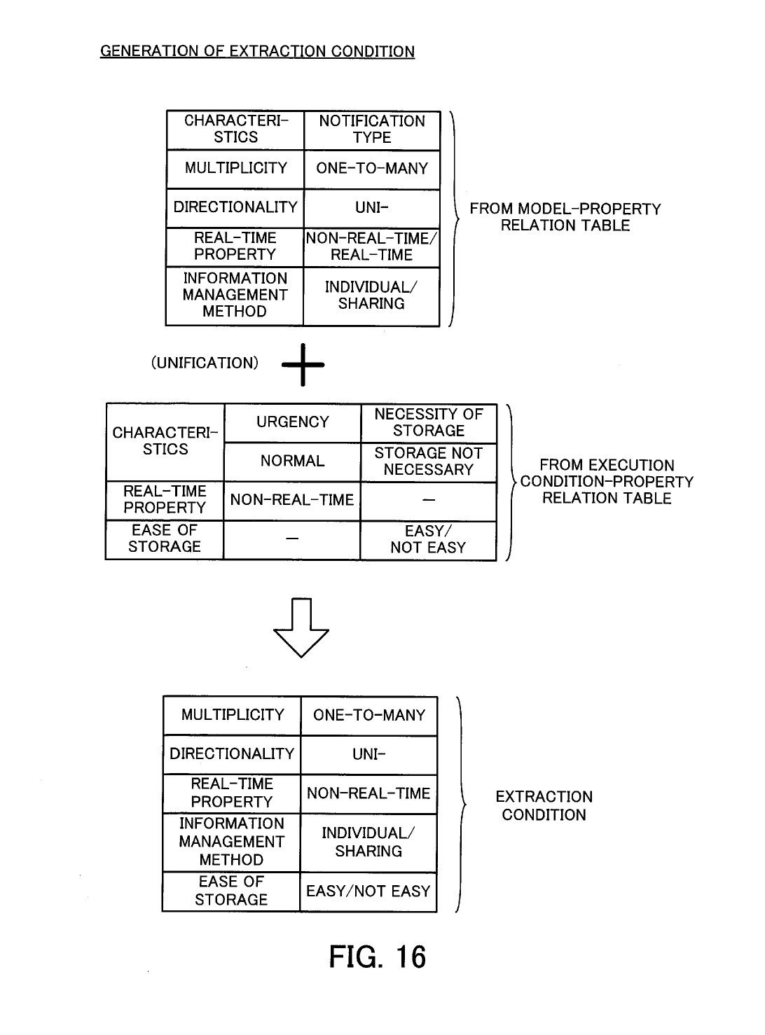

For example, when the work instance segment illustrated in FIG. 15 is extracted by the text analysis unit 341, the tool determining unit 345 generates an extraction condition of the communication tool by a method such as that illustrated in FIG. 16. FIG. 16 is an explanatory drawing of a procedure of determining the extraction condition of a work model, among the procedures to be performed by the server device according to the second embodiment.

As illustrated in FIG. 16, a first set of properties is input to the tool determining unit 345 from the property extracting unit 343, the properties being such that the multiplicity is “one-to-many”, the directionality is “uni-”, the real-time property is “non-real-time/real-time”, and the information management method is “individual/sharing”. Furthermore, a second set of properties is input to the tool determining unit 345 from the execution condition extracting unit 344, the properties being such that the real-time property is “non-real-time” and the ease of storage is “easy/not easy”. Subsequently, the tool determining unit 345 unifies the first and second sets of properties.

First, the tool determining unit 345 executes a unification procedure for the term “real-time property” common to the first and second sets of properties. The real-time property is “non-real-time/real-time” in the first set of properties, whereas the real-time property is “non-real-time” in the second set of properties. Accordingly, the condition simultaneously satisfying the both is that the real-time property is “non-real-time”, and therefore the tool determining unit 345 sets the real-time property to “non-real-time”.

Next, the tool determining unit 345 combines the content of the term “real-time property” and the content of other terms that do not overlap between the first and second sets of properties, to generate an extraction condition. In the example of FIG. 16, an extraction condition is generated such that the multiplicity is “one-to-many”, the directionality is “uni-”, the real-time property is “non-real-time”, the information management method is “individual/sharing”, and the ease of storage is “easy/not easy”. Subsequently, the tool determining unit 345 refers to the tool property 326, and extracts a communication tool satisfying the extraction condition.

Referring to the tool property 326 illustrated in FIG. 4, the communication tool satisfying the extraction condition illustrated in FIG. 16 is a notification type communication tool. Therefore, the tool determining unit 345 determines the communication tool which is suitable for the work to be a notification type communication tool. The tool determining unit 345 then recommends the notification type communication tool to the user. When there is a plurality of communication tools satisfying the extraction condition, a plurality of communication tools may be presented to the user in descending order of the use frequency, allowing the user to select a communication tool for use.

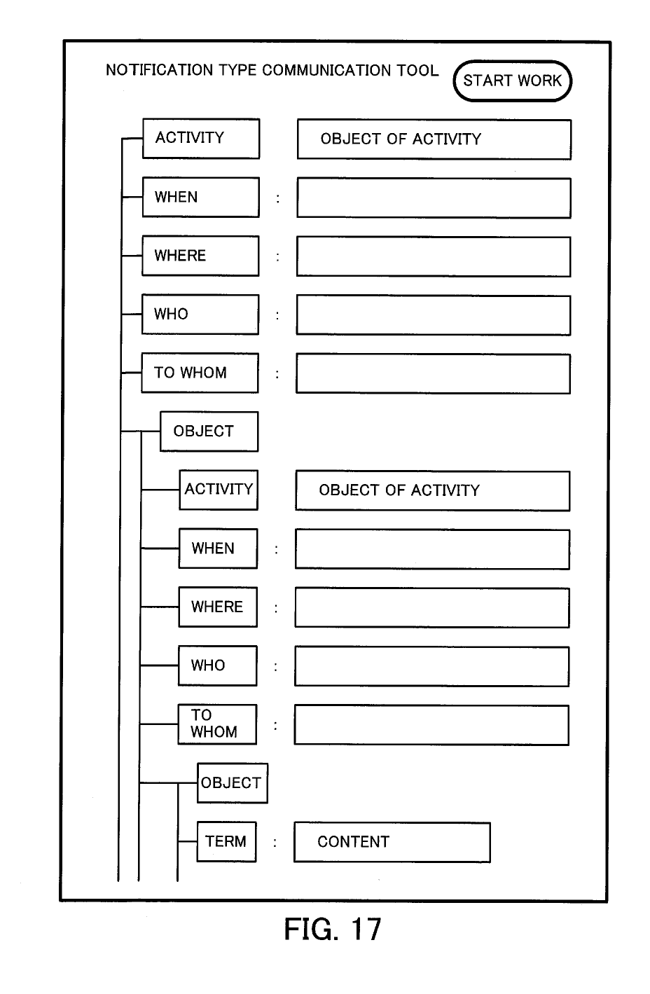

For example, the tool determining unit 345 causes the browser of the terminal device 200 to display a start screen of a notification type communication tool such as that illustrated in FIG. 17. FIG. 17 illustrates an exemplary start screen of a notification type communication tool according to the second embodiment.

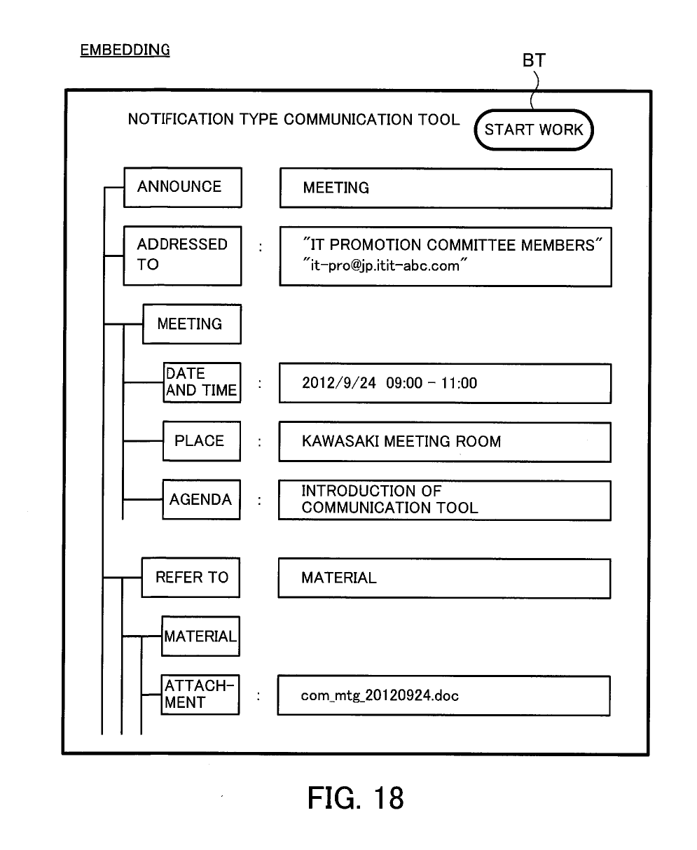

In this occasion, the tool determining unit 345 may embed a work element embedded in a work instance segment in an input term of the notification type communication tool, as illustrated in FIG. 18. FIG. 18 is an explanatory drawing of a procedure of embedding the work instance segment in the notification type communication tool, among the procedures to be performed by the server device according to the second embodiment. The user may start a work using the notification type communication tool by pressing a work start button BT. After start of the work, the function of the communication tool is provided by the tool function providing unit 301.

The function of the server device 300 according to the second embodiment has thus been described above.

### 2-5. Process Flow

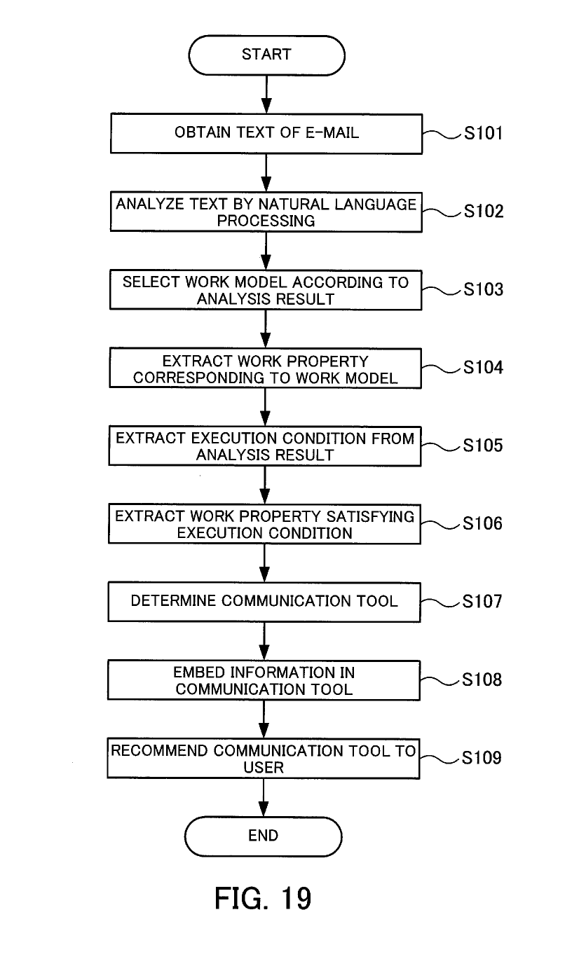

Next, the flow of recommendation procedure of communication tool according to the second embodiment will be described, referring to FIG. 19. FIG. 19 is a flowchart describing the flow of the recommendation procedure of the communication tool according to the second embodiment. The procedure illustrated in FIG. 19 is performed by the function of the server device 300.

(S101) The e-mail monitoring unit 303 obtains a text of an e-mail created by the user during the work. The timing of obtaining the text of the e-mail may be at transmission of the e-mail, or may be after transmission of the e-mail. The e-mail monitoring unit 303 which has obtained the e-mail inputs the text of the obtained e-mail to the text analysis unit 341.

(S102) The text analysis unit 341 performs natural language processing such as morphological analysis and syntax analysis on the text which is input from the e-mail monitoring unit 303 to analyze the content of the text. For example, the text analysis unit 341 analyzes the text structure by natural language processing and extracts an element (work element) of a term included in the set structure. The text analysis unit 341 then applies the extracted work element to the structure, to generate a work instance segment. The work instance segment generated by the text analysis unit 341 is input to the model selecting unit 342 and the execution condition extracting unit 344.

(S103) The model selecting unit 342 refers to the work model 321 stored in the storage unit 302, and checks a term having a group of words set thereto. In addition, the model selecting unit 342 extracts a work element applied to a work instance segment for the same term as the term having a group of words set thereto in the work model 321. Furthermore, the model selecting unit 342 determines whether or not the extracted work element corresponds to any of the group of words which is set to the work model 321.

Similarly, the model selecting region 342 performs a determination procedure for all the terms of the work model 321 having a group of words set thereto and, when it is determined that all the terms correspond, the model selecting region 342 selects the work model 321 as a candidate. When there is a plurality of candidates, the model selecting unit 342 refers to the model use frequency 322 (see FIG. 10, for example) stored in the storage unit 302, and selects one of the work models 321 from among the candidates. When, on the other hand, there is only one candidate, the model selecting unit 342 outputs the selected work model 321 as the final selection result. The work model 321 selected by the model selecting unit 342 is input to the property extracting unit 343.

(S104) The property extracting unit 343 extracts the property of the communication tool corresponding to the work model 321 selected by the model selecting unit 342. In this occasion, the property extracting unit 343 uses the model-property relation table 323 stored in the storage unit 302. The property extracted by the property extracting unit 343 is input to the tool determining unit 345.

(S105) The execution condition extracting unit 344 extracts the execution condition corresponding to the work instance segment which is input from the text analysis unit 341.

(S106) The execution condition extracting unit 344 refers to the execution condition-property relation table 324 stored in the storage unit 302 (see FIG. 12), and extracts the property of the communication tool satisfying the extracted execution condition. The property extracted by the execution condition extracting unit 344 is input to the tool determining unit 345.

(S107) The tool determining unit 345 combines the properties of the communication tool which are input from the property extracting unit 343 and the properties of the communication tool which are input from the execution condition extracting unit 344, to generate an extraction condition of the communication tool. The tool determining unit 345 then uses the tool use frequency 325 and the tool property 326 stored in the storage unit 302 to determine the communication tool satisfying the generated extraction condition.

(S108) The tool determining unit 345 extracts a work element embedded in the work instance segment. The tool determining unit 345 then embeds the extracted work element in the input term of the communication tool.

(S109) The tool determining unit 345 recommends the notification type communication tool to the user. For example, the tool determining unit 345 causes the browser of the terminal device 200 to display the start screen of the communication tool in which a work element is embedded. Upon completion of the process of S109, the series of processes illustrated in FIG. 19 are terminated.

The flow of the recommendation procedure of the communication tool according to the second embodiment has thus been described above.

### 2-6. Application Examples

The foregoing description has focused on an example of selecting a notification type communication tool. In the following, an example of applying a technique according to the second embodiment will be described about a case which has not been illustrated above. It goes without saying that the applicable range of the technique according to the second embodiment is not limited to such application examples and may be extended to any range conceivable by a person skilled in the art from such application examples.

### Application Example A

### Notification Type (ASAP/Important)

An application example A will be described.

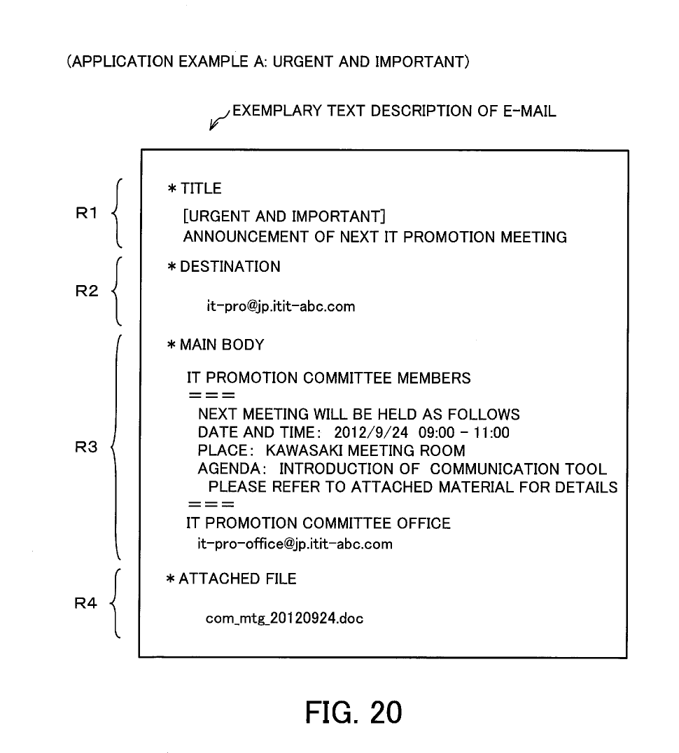

An application example A is a case where the urgency and significance are determined to be high. As an example, there is considered a case where a text of an e-mail illustrated in FIG. 20 is obtained. FIG. 20 illustrates an exemplary text description of an e-mail to be processed by the server device according to an application example (application example A) of the second embodiment.

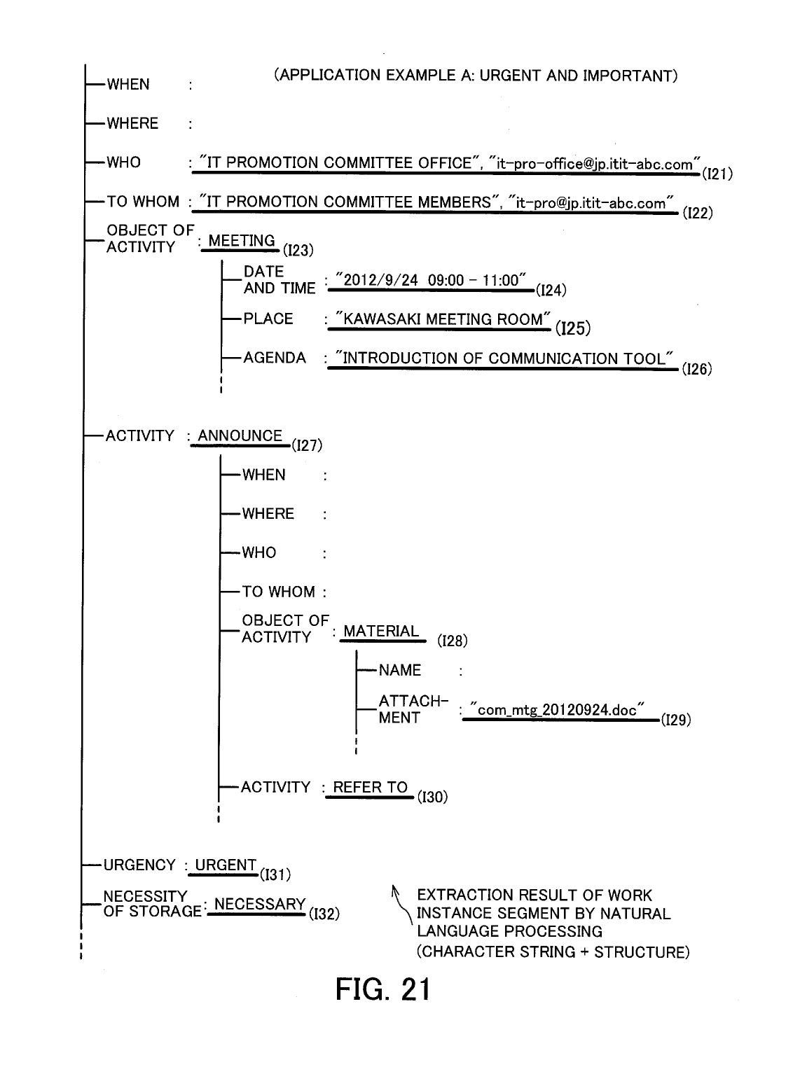

Upon input of the text of the e-mail illustrated in FIG. 20, the text analysis unit 341 extracts a work element by natural language processing and, as illustrated in FIG. 21, applies the extracted work element to a corresponding term. FIG. 21 illustrates an exemplary work instance segment extracted from the e-mail by the server device according to an application example (application example A) of the second embodiment.

Performing morphological analysis and syntax analysis on the title R1 (see FIG. 20) allows a verb “announce” and its object “meeting” to be extracted. The text analysis unit 341 therefore applies “announce” to the term “activity” (code I27 of FIG. 21) and applies “meeting” to the term “object of activity” (code I23 of FIG. 21). Similarly, the text analysis unit 341 analyzes the destination R2 and the main body R3 (see FIG. 20) and applies “IT promotion committee office” and “it-pro-office@jp.itit-abc.com” extracted from the text to the term “who” (code I21 of FIG. 21).

In addition, the text analysis unit 341 analyzes the destination R2 and the main body R3 (see FIG. 20) and applies “IT promotion committee members” and “it-pro@jp.itit-abc.com” extracted from the text to the term “to whom” (code I22 of FIG. 21). Furthermore, the text analysis unit 341 applies “2012/9/24 09:00-11:00”, “Kawasaki meeting room”, and “introduction of communication tool” extracted from the text to the terms “date and time”, “place”, and “agenda” (codes I24, I25 and I26 of FIG. 21), respectively.

In addition, the text analysis unit 341 analyzes the main body R3 (see FIG. 20) and applies “material” extracted from the text to the term “object of activity” (code I28 of FIG. 21). Furthermore, the text analysis unit 341 analyzes the attached file name R4 (see FIG. 20) and applies “com_mtg_{—}20120924.doc” extracted from the text to the term “attachment” (code I29 of FIG. 21). In addition, the text analysis unit 341 analyzes the main body R3 (see FIG. 20) and applies “refer to” to the term “activity” (code I30 of FIG. 21), based on the analysis result.

In addition, the text analysis unit 341 extracts a character string expressing urgency such as “ASAP”, “hurry”, and “urgent” from the text of the title R1 and the main body R3 (see FIG. 20). In the example of FIG. 20, a character string “URGENT” is extracted. Therefore, the text analysis unit 341 sets the term “urgency” (code I31 of FIG. 21) to “URGENT”.

In addition, the text analysis unit 341 extracts a character string expressing significance such as “important” or “necessary . . . ” from the text of the title R1 and the main body R3 (see FIG. 20). In the example of FIG. 20, a character string “important” is extracted. Therefore, the text analysis unit 341 sets the term “necessity of storage” (code I32 of FIG. 21) to “necessary”.

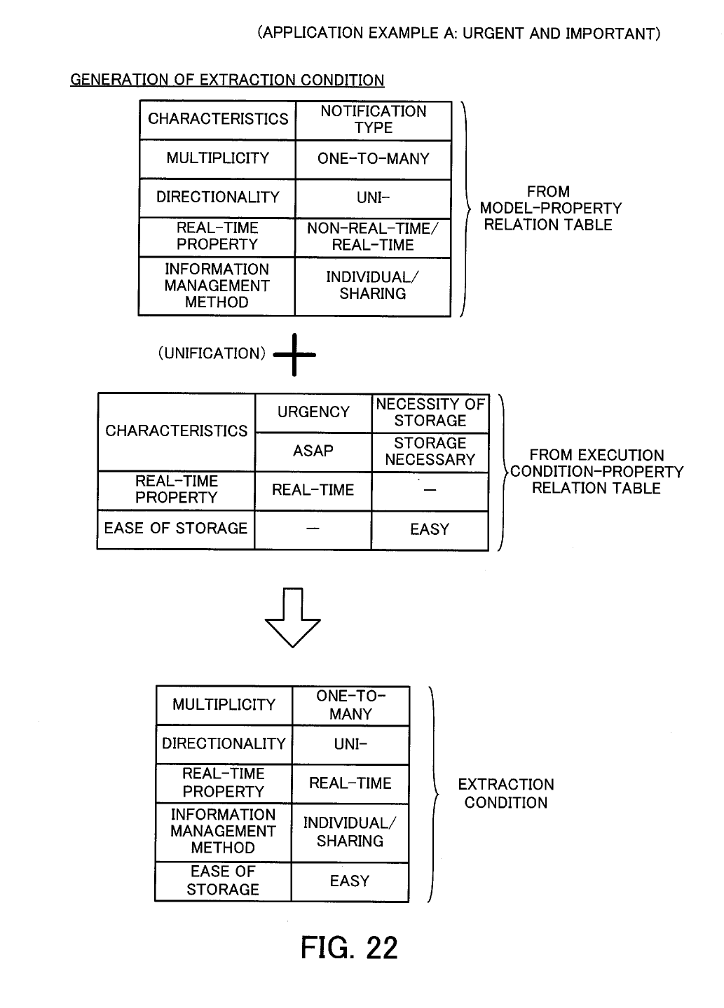

When a work instance segment illustrated in FIG. 21 is obtained, properties such as those illustrated in FIG. 22 are extracted from the work instance segment by the property extracting unit 343 and the execution condition extracting unit 344, and an extraction condition of a communication tool is generated by the tool determining unit 345. FIG. 22 is an explanatory drawing of a procedure of determining the extraction condition of the work model, among the procedures to be performed by the server device according to an application example (application example A) of the second embodiment.

As illustrated in FIG. 22, properties such that the multiplicity is “one-to-many”, the directionality is “uni-”, the real-time property is “non-real-time/real-time”, and the information management method is “individual/sharing” are extracted by the property extracting unit 343. On the other hand, properties such that the real-time property is “real-time” and the ease of storage is “easy” are extracted by the execution condition extracting unit 344. In this case, an extraction condition with the multiplicity being “one-to-many”, the directionality being “uni-”, the real-time property being “real-time”, the information management method being “individual/sharing”, and the ease of storage being easy” is generated by the tool determining unit 345.

The application example A has thus been described above.

### Application Example B

### Discussion Type

An application example B will be described.

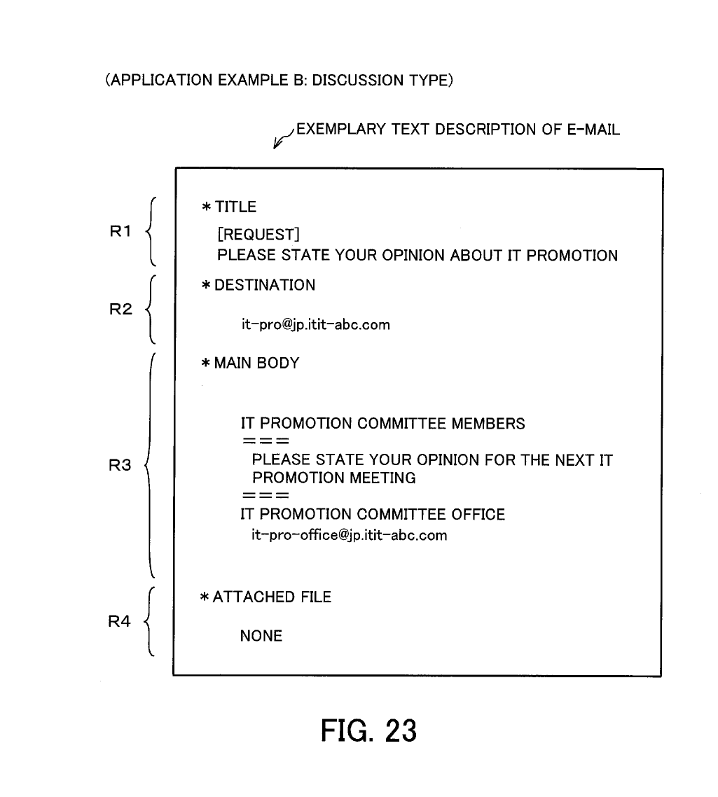

The application example B is a case where a discussion type communication tool is determined to be suitable. As an example, there is considered a case where a text of an e-mail illustrated in FIG. 23 is obtained. FIG. 23 illustrates an exemplary text description of an e-mail to be processed by the server device according to an application example (application example B) of the second embodiment.

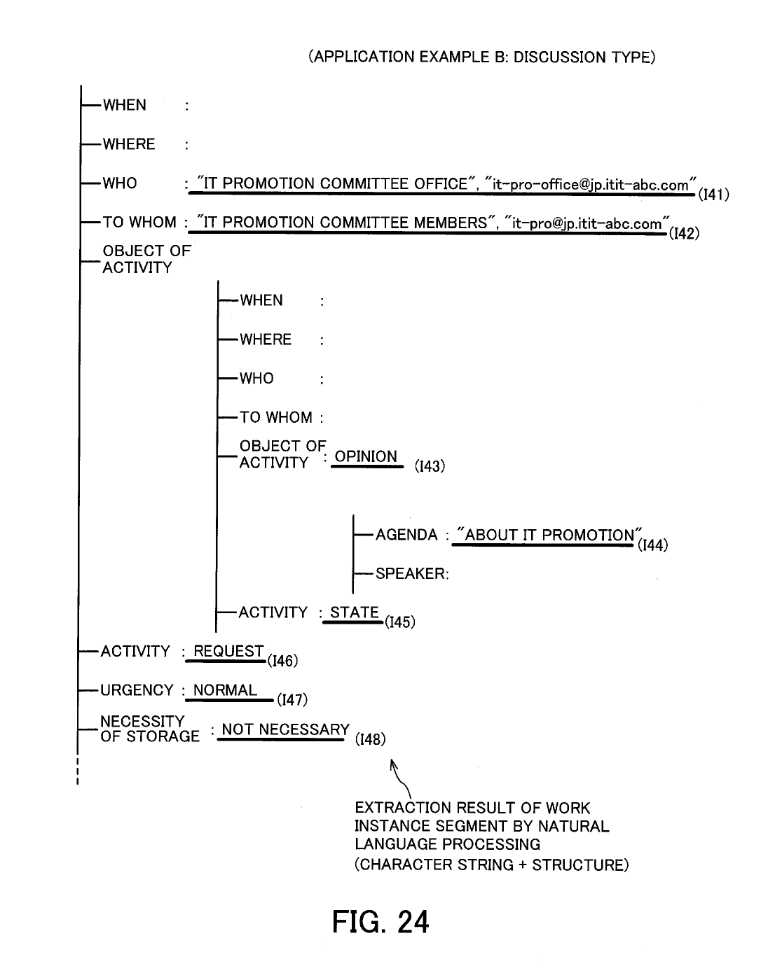

Upon input of the text of the e-mail illustrated in FIG. 23, the text analysis unit 341 extracts a work element by natural language processing, as illustrated in FIG. 24, applies the extracted work element to a corresponding term. FIG. 24 illustrates an exemplary work instance segment extracted from the e-mail by the server device according to an application example (application example B) of the second embodiment.

Performing morphological analysis and syntax analysis on the title R1 (see FIG. 23) allows a verb “request” to be extracted. Furthermore, a verb “state” and its object “opinion” forming an objective phrase of the verb “request” may be extracted. The text analysis unit 341 therefore applies “request” to the term “activity” (code I46 of FIG. 24), applies, “opinion” to the term “object of activity” (code I43 of FIG. 24), and applies “state” to the term “activity” (code I45 of FIG. 24).

In addition, the text analysis unit 341 applies, to the “agenda” term (code I44 of FIG. 24), a character string “about IT promotion” indicating the content of the agenda that may be extracted from the title R1 (see FIG. 23). In addition, the text analysis unit 341 analyzes the destination R2 and the main body R3 (see FIG. 23), and applies “IT promotion committee office” and “it-pro-office@jp.itit-abc.com” extracted from the text to the term “who” (code I41 of FIG. 24). In addition, the text analysis unit 341 analyzes the destination R2 and the main body R3 (see FIG. 23), and applies “IT promotion committee members” and “it-pro@jp.itit-abc.com” extracted from the text to the term “to whom” (code I42 of FIG. 24).

In addition, the text analysis unit 341 extracts a character string expressing urgency such as “ASAP”, “hurry”, and “urgent” from the text of the title R1 and the main body R3 (see FIG. 23). In the example of FIG. 23, no character string expressing urgency is extracted and therefore the text analysis unit 341 sets the term “urgency” (code I47 of FIG. 24) to “normal”. In addition, the text analysis unit 341 extracts a character string expressing significance such as “important” or “necessary . . . ” from the text of the title R1 and the main body R3 (see FIG. 23). In the example of FIG. 23, no character string expressing significance is extracted and therefore the text analysis unit 341 sets the term “necessity of storage” (code I48 of FIG. 24) to “not necessary”.

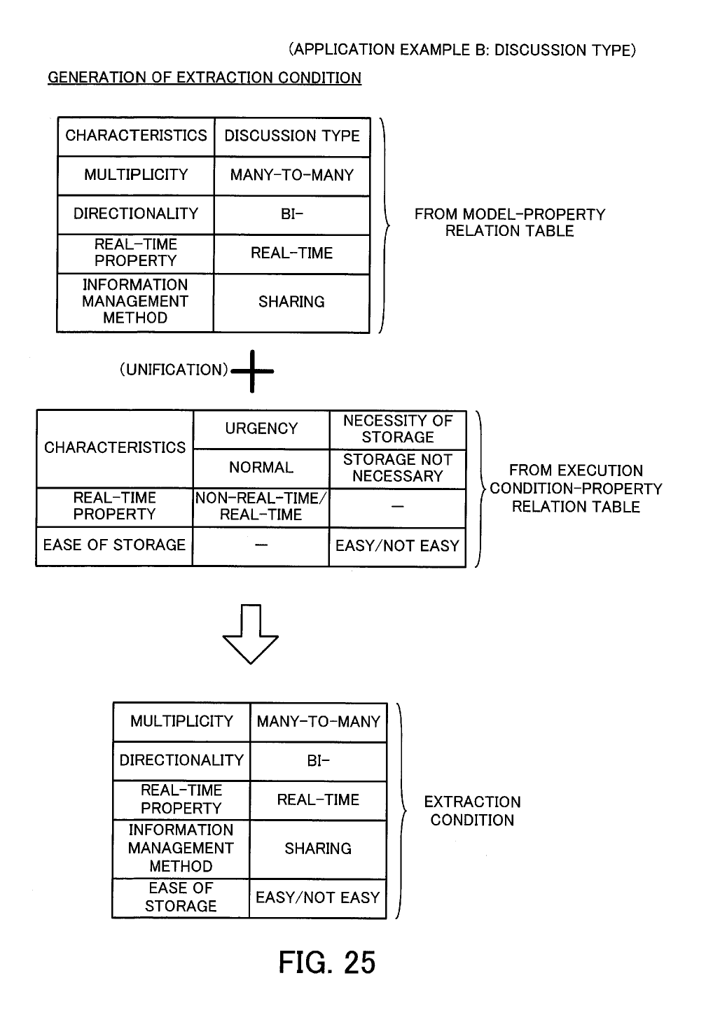

When a work instance segment illustrated in FIG. 24 is obtained, properties such as those illustrated in FIG. 25 are extracted from the work instance segment by the property extracting unit 343 and the execution condition extracting unit 344, and an extraction condition of a communication tool is generated by the tool determining unit 345. FIG. 25 is an explanatory drawing of a procedure of determining the extraction condition of the work model, among the procedures to be performed by the server device according to an application example (application example B) of the second embodiment.

As illustrated in FIG. 25, properties such that the multiplicity is “many-to-many”, the directionality is “bi-”, the real-time property is “real-time”, and the information management method is “sharing” are extracted by the property extracting unit 343. On the other hand, properties such that the real-time property is “non-real-time/real-time” and the ease of storage is “easy/not easy” are extracted by the execution condition extracting unit 344. In this case, an extraction condition with the multiplicity being “many-to-many”, the directionality being “bi-”, the real-time property being “real-time”, the information management method being “sharing”, and the ease of storage being “easy/not easy” is generated by the tool determining unit 345.

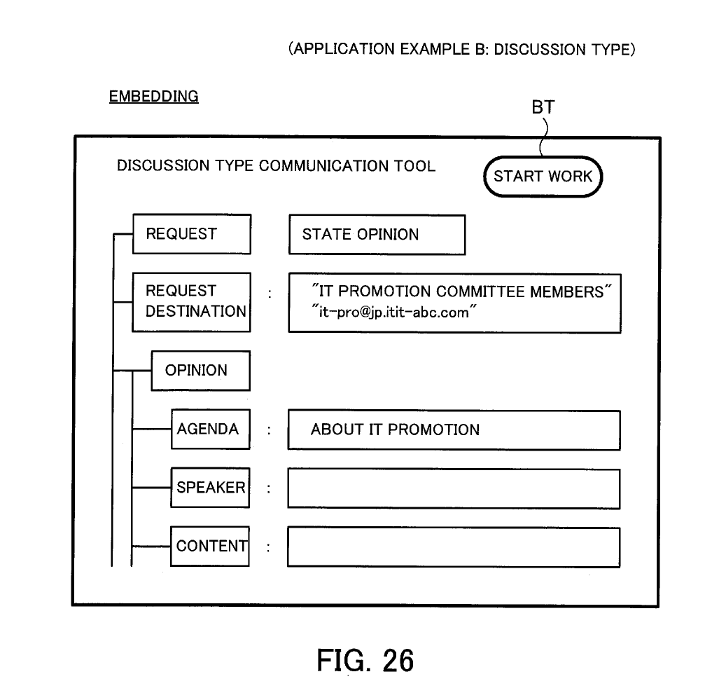

Referring to FIGS. 3 and 4, the communication tool satisfying the aforementioned extraction condition is a discussion type communication tool. The tool determining unit 345 embeds the work element extracted from the work instance segment in the discussion type communication tool, as illustrated in FIG. 26, and displays the start screen of the discussion type communication tool. FIG. 26 is an explanatory drawing of a procedure of embedding the work instance segment in the discussion type communication tool, among the procedures to be performed by the server device according to an application example (application example B) of the second embodiment.

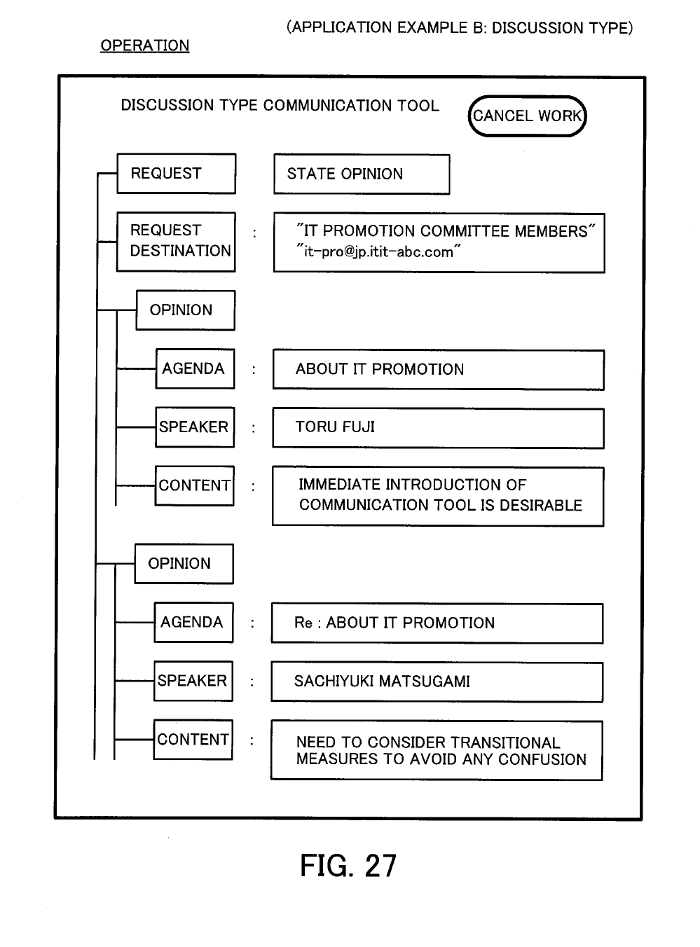

When the user presses the work start button BT, a work is started using a discussion type communication tool, as illustrated in FIG. 27. FIG. 27 is an explanatory drawing of an exemplary operation of a discussion type communication tool according to an application example (application example B) of the second embodiment. In the case of a discussion type communication tool, a group of people participates in the work. Accordingly, there may be provided a mechanism which notifies the user participating in the work of the start-of-work using the discussion type communication tool, in response to a click on the work start button BT.

For example, the tool determining unit 345 refers to the term “to whom” of the work instance segment corresponding to a request destination of the work and specifies the request destination, and presents the operation screen of the discussion type communication tool to the specified request destination. There may be a mechanism which transmits an e-mail having a link that displays the operation screen of the discussion type communication tool to the specified request destination. In addition, there may be a mechanism which displays a popup window prompting participation to the discussion type communication tool on the screen of the terminal device 200 being used by a user belonging to the specified request destination.

The application example B has thus been described above.

### Application Example C

### Cooperative Type

Next, an application example C will be described.

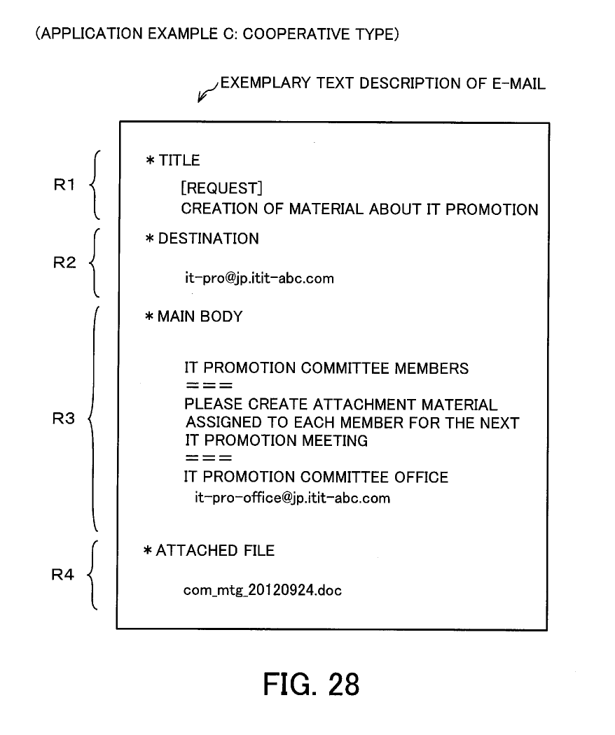

The application example C is a case where a cooperative type communication tool is determined to be suitable. As an example, there is considered a case where a text of an e-mail illustrated in FIG. 28 is obtained. FIG. 28 illustrates an exemplary text description of an e-mail to be processed by the server device according to an application example (application example C) of the second embodiment.

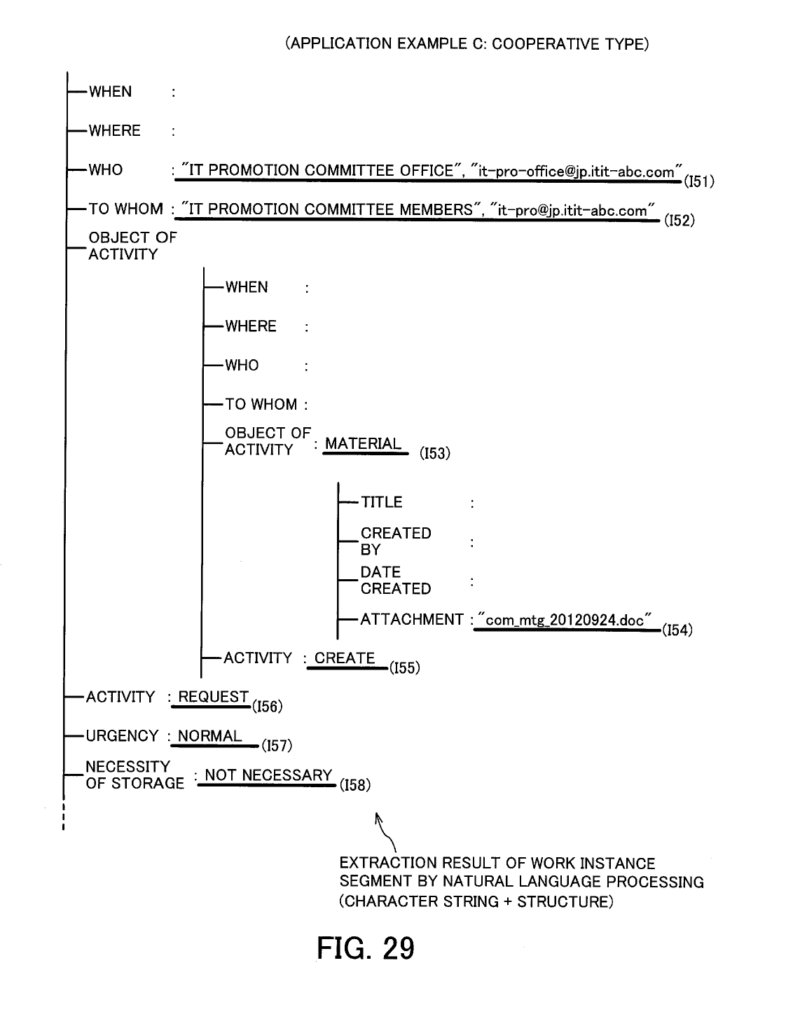

Upon input of the text of the e-mail illustrated in FIG. 28, the text analysis unit 341 extracts a work element by natural language processing, as illustrated in FIG. 29, applies the extracted work element to a corresponding term. FIG. 29 illustrates an exemplary work instance segment extracted from the e-mail by the server device according to an application example (application example C) of the second embodiment.

Performing morphological analysis and syntax analysis on the title R1 (see FIG. 28) allows a verb “request” to be extracted. Furthermore, a verb “create” and its object “material” forming an objective phrase of the verb “request” may be extracted. The text analysis unit 341 therefore applies “request” to the term “activity” (code I56 of FIG. 29), applies “material” to the term “object of activity” (code I53 of FIG. 29), and applies “create” to the term “activity” (code I55 of FIG. 29).

In addition, the text analysis unit 341 applies the character string “com_mtg_{—}20120924.doc” which may be extracted from the attached file name R4 (see FIG. 28) to the term “attachment” (code I54 of FIG. 29). In addition, the text analysis unit 341 analyzes the destination R2 and the main body R3 (see FIG. 28), and applies “IT promotion committee office” and “it-pro-office@jp.itit-abc.com” extracted from the text to the term “who” (code I51 of FIG. 29). In addition, the text analysis unit 341 analyzes the destination R2 and the main body R3 (see FIG. 28), and applies “IT promotion committee members” and “it-pro@jp.itit-abc.com” extracted from the text to the term “to whom” (code I52 of FIG. 29).

In addition, the text analysis unit 341 extracts a character string expressing urgency such as “ASAP”, “hurry”, and “urgent” from the text of the title R1 and the main body R3 (see FIG. 28). In the example of FIG. 28, no character string expressing urgency is extracted and therefore the text analysis unit 341 sets the term “urgency” (code I57 of FIG. 29) to “normal”. In addition, the text analysis unit 341 extracts a character string expressing significance such as “important” or “necessary . . . ” from the text of the title R1 and the main body R3 (see FIG. 28). In the example of FIG. 28, no character string expressing significance is extracted and therefore the text analysis unit 341 sets the term “necessity of storage” (code I58 of FIG. 29) to “not necessary”.

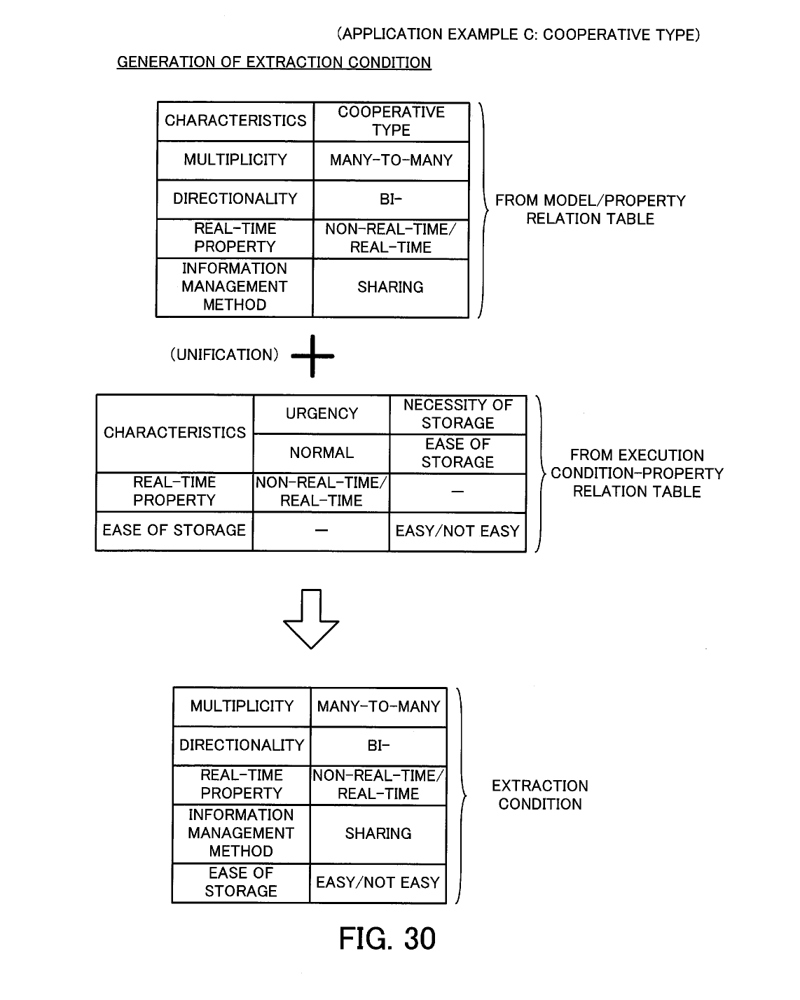

When a work instance segment illustrated in FIG. 29 is obtained, properties such as those illustrated in FIG. 30 are extracted from the work instance segment by the property extracting unit 343 and the execution condition extracting unit 344, and an extraction condition of a communication tool is generated by the tool determining unit 345. FIG. 30 is an explanatory drawing of a procedure of determining the extraction condition of the work model, among the procedures to be performed by the server device according to an application example (application example C) of the second embodiment.

As illustrated in FIG. 30, properties such that the multiplicity is “many-to-many”, the directionality is “bi-”, the real-time property is “non-real-time/real-time”, and the information management method is “sharing” are extracted by the property extracting unit 343. On the other hand, properties such that the real-time property is “non-real-time/real-time” and the ease of storage is “easy/not easy” are extracted by the execution condition extracting unit 344. In this case, an extraction condition with the multiplicity being “many-to-many”, the directionality being “bi-”, the real-time property being “non-real-time/real-time”, the information management method being “sharing”, and the ease of storage being “easy/not easy” are generated by the tool determining unit 345.

Referring to FIGS. 3 and 4, the communication tool satisfying the aforementioned extraction condition is a cooperative type communication tool. Since a discussion type communication tool also satisfies the extraction condition, one of the communication tools is selected according to the use frequency described in the tool use frequency 325, or both communication tools are presented to the user as candidates. However, the following description will go on assuming that a cooperative type communication tool is selected according to the use frequency.

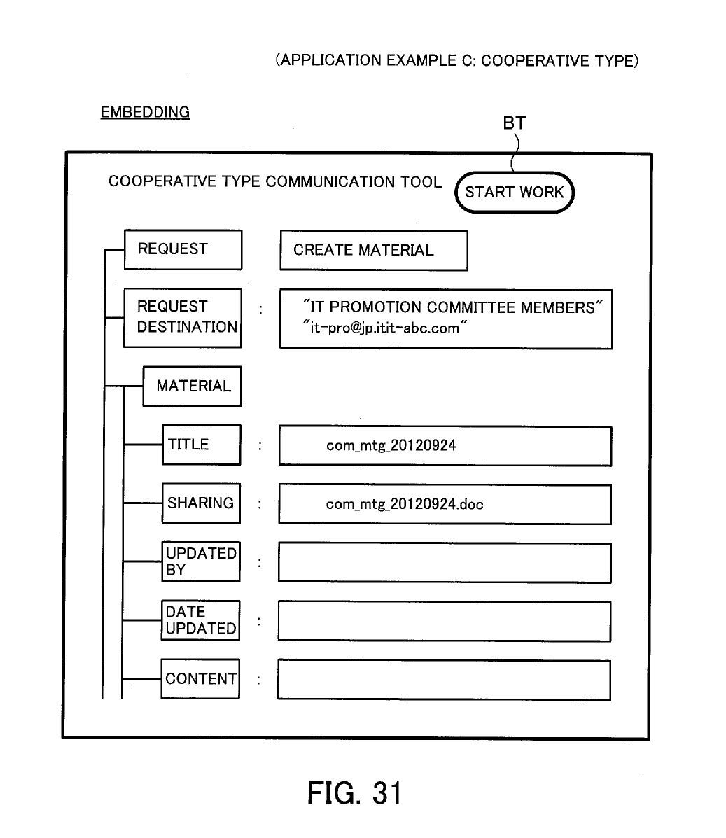

The tool determining unit 345 embeds the work element extracted from the work instance segment in a cooperative type communication tool, and displays the start screen of the cooperative type communication tool, as illustrated in FIG. 31. FIG. 31 is an explanatory drawing of a procedure of embedding the work instance segment in the cooperative type communication tool, among the procedures to be performed by the server device according to an application example (application example C) of the second embodiment.

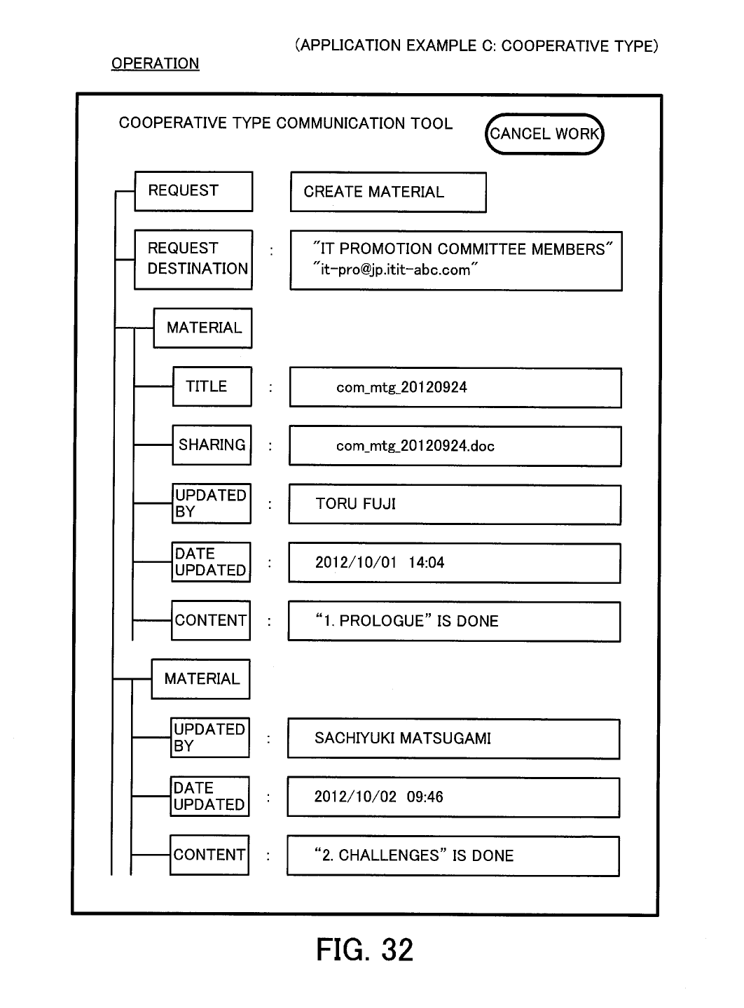

When the user presses the work start button BT, a work is started using a cooperative type communication tool, as illustrated in FIG. 32. FIG. 32 is an explanatory drawing of an exemplary operation of a cooperative type communication tool according to an application example (application example C) of the second embodiment. In the case of a cooperative type communication tool, a group of people participates in the work. Accordingly, there may be provided a mechanism which notifies the user participating in the work of the start-of-work using the cooperative type communication tool, in response to a click on the work start button BT.

For example, the tool determining unit 345 refers to the term “to whom” of a work instance segment corresponding to a request destination of the work and specifies the request destination, and presents the operation screen of the cooperative type communication tool to the specified request destination. There may be a mechanism which transmits an e-mail having a link that displays the operation screen of the cooperative type communication tool to the specified request destination. In addition, there may be a mechanism which displays a popup window promoting activation of the cooperative type communication tool on the screen of the terminal device 200 being used by a user belonging to the specified request destination.

The application example C has thus been described above.

As has been discussed above, the technique according to the second embodiment may be applied to various cases.

The second embodiment has thus been described above.

According to the present invention, a communication tool which is suitable for the work may be selected with a higher possibility.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable storage medium storing a computer program that causes a computer to execute a process comprising:
referring to information of work models each associating an attribute of a work tool with a pair of an object character string related to a work object and an activity character string including verbs related to work activities, the information being stored in a memory, to detect a pair of an object character string and an activity character string from an e-mail;
specifying a work model corresponding to the detected pair; and
specifying the work tool having the attribute corresponding to the specified work model.

2. The non-transitory computer-readable storage medium according to claim 1, wherein the process further includes:
extracting setting information settable to the specified work tool from a result of natural language processing on the e-mail; and
setting the setting information to the work tool.

3. The non-transitory computer-readable storage medium according to claim 1, wherein the specifying the work tool includes determining based on a result of performing natural language processing on the e-mail whether or not to store information exchanged between users participating in a work, and specifying the work tool in consideration of a result of the determining.

4. The non-transitory computer-readable storage medium according to claim 1, wherein the specifying the work tool includes determining urgency of a work based on a result of performing natural language processing on the e-mail, and specifying the work tool in consideration of a result of the determining.

5. The non-transitory computer-readable storage medium according to claim 1, wherein the process further includes:
counting a frequency of use of the specified work tool by a user; and
preferentially selecting a work tool being high in the frequency when specifying the work tool.

6. A tool selection method comprising:
referring, by a processor of a computer, to information of work models each associating an attribute of a work tool with a pair of an object character string related to a work object and an activity character string including verbs related to work activities, the information being stored in a memory, to detect a pair of an object character string and an activity character string from an e-mail;
specifying, by the processor of the computer, a work model corresponding to the detected pair; and
specifying, by the processor of the computer, the work tool having the attribute corresponding to the specified work model.
